(19) United States
(12) Patent Application Publication
(10) Pub. No.: US 2020/0296189 A1
(43) Pub. Date: Sep. 17, 2020

(54) PACKET ANALYSIS APPARATUS, PACKET ANALYSIS METHOD, AND STORAGE MEDIUM

(71) Applicant: FUJITSU LIMITED, Kawasaki-shi (JP)

(72) Inventor: Chunghan Lee, Yokohama (JP)

(73) Assignee: FUJITSU LIMITED, Kawasaki-shi (JP)

(21) Appl. No.: 16/801,216

(22) Filed: Feb. 26, 2020

(30) Foreign Application Priority Data
Mar. 11, 2019 (JP) 2019-044219

(51) Int. Cl. H04L 29/06; H04L 12/721; H04L 12/741

(52) U.S. Cl. CPC H04L 69/22; H04L 45/745; H04L 45/72; H04L 45/38

(57) ABSTRACT

A storage medium storing a program that causes a processor to execute a process, the process includes collecting packets transmitted among nodes including first nodes that provide services and communicate with each other and a second node that receives a notification packet indicating that a packet corresponding to a data flow of a sampling target has been transferred from each of first nodes, identifying a plurality of notification packets whose destination is the second node in the collected packets, and acquiring a plurality of transmission source addresses of the plurality of notification packets identified, and extracting, from the collected packets, candidate packets having a set of two addresses in transmission source addresses acquired as a transmission source and a destination, and deciding a set of packets corresponding to the data flow of the sampling target from the candidate packets extracted.

### CROSS-REFERENCE TO RELATED APPLICATION

This application is based upon and claims the benefit of priority of the prior Japanese Patent Application No. 2019-44219, filed on Mar. 11, 2019, the entire contents of which are incorporated herein by reference.

### FIELD

The embodiments discussed herein are related to a packet analysis program, a packet analysis apparatus, and a packet analysis method.

### BACKGROUND

Presently, information processing systems including plural information processing apparatuses such as computers are used. The respective information processing apparatuses are coupled to a network in a wired or wireless manner and mutually communicate.

For example, there is a proposal for an information processing system that causes operation of plural containers that execute plural services on a container base of one or more host computers and executes processing of a certain task by cooperation between services. The information processing system of the proposal includes a computer that acquires communication data of all services and estimates the parent-child relationship between services based on the flow of communication between the services corresponding to a task configured by plural services. The computer deems a series of processing from transmission of a request from a certain service to another service to reception of an acknowledgement as one unit and refers to the processing as a span, and represents the parent-child relationship between micro-services by the parent-child relationship between spans. For example, if a first span corresponding to communication from a first service to a second service is called by a second span corresponding to communication from the second service to a third service, the parent-child relationship in which the second span from the viewpoint of the first span is the child span and the first span from the viewpoint of the second span is the parent span is estimated. In this proposal, it is also considered to grasp the relationship between services by assigning a unique trace identifier (ID) to a request by a client and causing the trace ID to be sequentially taken over to the next communication.

There is also a proposal for a data flow analysis apparatus that selects a specific packet stream from packet streams transferred on a network and generates a feature vector having scores of the respective keywords as the respective elements based on plural keywords included in the specific packet stream. The data flow analysis apparatus of the proposal outputs change in the latent interest state of a user as a series through applying to a model that holds the occurrence probability of the keyword in a time-series manner with respect to the series of the feature vector.

For example, Japanese Laid-open Patent Publication No. 2018-81440, Japanese Laid-open Patent Publication No. 2011-48488, and so forth are disclosed as related arts.

### SUMMARY

According to an aspect of the embodiments, 1.A non-transitory computer-readable storage medium storing a program that causes a processor included in computer to execute a process, the process includes collecting packets transmitted among a plurality of nodes including a plurality of first nodes that provide services and communicate with each other and a second node that receives a notification packet indicating that a packet corresponding to a data flow of a sampling target has been transferred from each of the plurality of first nodes, identifying a plurality of notification packets whose destination is the second node in the collected packets, and acquiring a plurality of transmission source addresses of the plurality of notification packets identified, and extracting, from the collected packets, a plurality of candidate packets having a set of two addresses in the plurality of transmission source addresses acquired as a transmission source and a destination, and deciding a set of packets corresponding to the data flow of the sampling target from the plurality of candidate packets extracted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a packet analysis apparatus of a first embodiment;

FIG. 2 is a diagram illustrating an example of an information processing system of a second embodiment;

FIG. 3 is a block diagram illustrating a hardware example of an analysis apparatus;

FIG. 4 is a diagram illustrating an example of spans;

FIG. 5 is a diagram illustrating an example of trace information added to an HTTP header;

FIG. 6 is a diagram illustrating an example of collection of span information by a span collector;

FIG. 7 is a diagram illustrating an example of an HTTP header for a packet group;

FIGS. 8A and 8B are diagrams illustrating an example of headers included in a packet;

FIG. 9 is a block diagram illustrating a function example of an analysis apparatus;

FIG. 10 is a diagram illustrating an example of a filter table;

FIG. 11 is a diagram illustrating an example of a trace estimation information table;

FIG. 12 is a diagram illustrating an example of a candidate trace management table;

FIG. 13 is a diagram illustrating an example of span management tables;

FIG. 14 is a diagram illustrating a prediction example of matching timing;

FIG. 15 is a diagram illustrating a relationship between layers;

FIG. 16 is a diagram illustrating a processing example of an information processing system;

FIG. 17 is a flowchart illustrating a packet collection example;

FIG. 18 is a flowchart illustrating a packet collection example (sequel);

FIG. 19 is a flowchart illustrating a packet collection example (sequel);

FIG. 20 is a flowchart illustrating an identification example of a packet;

FIG. 21 is a diagram illustrating a first example of matching of a candidate trace;

FIGS. 22A and 22B are diagrams illustrating a first example of an analysis sequence;

FIG. 23 is a diagram illustrating a second example of matching of a candidate trace;

FIGS. 24A and 24B are diagrams illustrating a second example of an analysis sequence; and

FIG. 25 is a diagram illustrating another hardware example of an analysis apparatus.

### DESCRIPTION OF EMBODIMENTS

In an information processing system, monitoring is often carried out about performance of a series of processing by cooperation of plural services provided by plural nodes. However, in the information processing system, possibly a large amount of data is communicated between services. Acquiring and analyzing all data takes a long time and is difficult. Thus, it is conceivable that the sampling is carried out with focus on part of data flows. In the sampling, at each node, communication data communicated over plural services is often allowed to be identified as communication data that belongs to a data flow of a sampling target.

For example, in order to allow the data flow of the sampling target to be identified, each node may insert identification information indicating that communication data is the sampling target in the header (for example, hypertext transfer protocol (HTTP) header or the like) of the communication data that belongs to the data flow. Each node executes the series of processing while carrying out insertion of the identification information in communication data to be sent to the next service and removal of the identification information for received communication data. In addition thereto, each node may notify reception or transmission of the communication data including the identification information to a monitoring node that carries out the monitoring. This allows the monitoring node to measure the performance of the series of processing associated with cooperation of plural services based on the time difference in the reception clock time of the notifications from the respective nodes, for example.

Meanwhile, according to the measurement result of the performance associated with cooperation of plural services like that described above, packets in a packet layer of transmission control protocol/internet protocol (TCP/IP) lower than a layer (for example, message layer of HTTP) of the protocol of the communication data that belongs to the data flow deemed as the sampling target are often analyzed. The purpose thereof is to analyze problems of the communication path and so forth in the layer of TCP/IP. For this purpose, for example, it is conceivable that packets communicated between services are collected and, based on the collected packets, analysis of the identification information in the header of communication data is carried out to identify the packets that configure the data flow. However, when construction and analysis of the header of communication data is carried out for a large amount of collected packets, it takes a long time to estimate the packets that belong to the data flow of the sampling target.

In one aspect, the embodiments discussed herein intend to provide a packet analysis program, a packet analysis apparatus, and a packet analysis method that may enhance the speed of estimation of packets that belong to a data flow of a sampling target.

The present embodiments will be described below with reference to the drawings.

### First Embodiment

A first embodiment will be described.

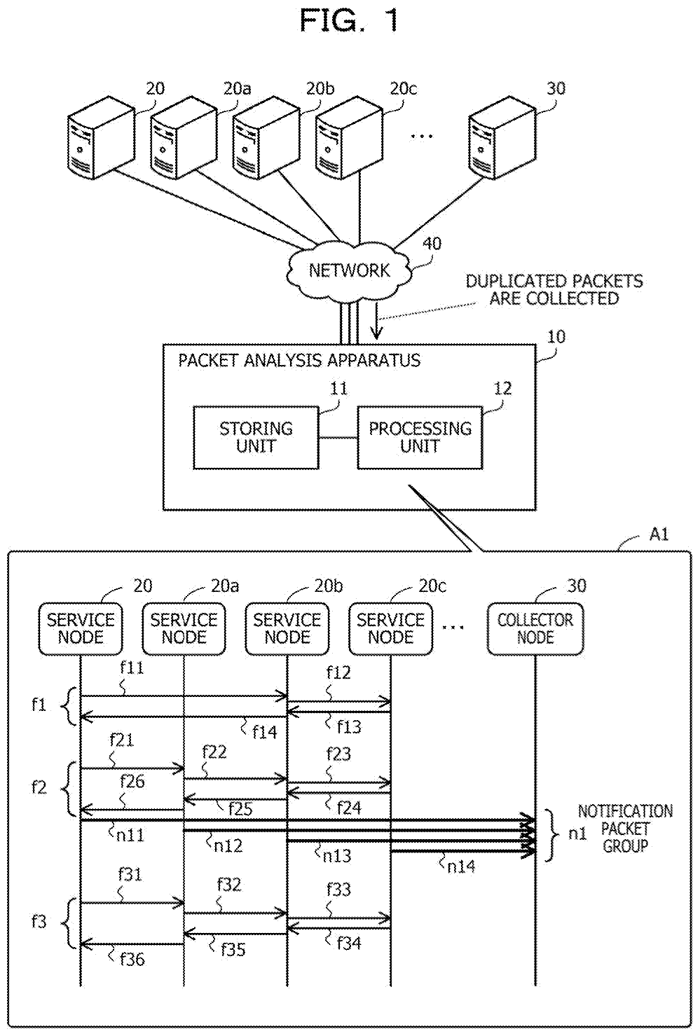

FIG. 1 is a diagram illustrating a packet analysis apparatus of the first embodiment.

A packet analysis apparatus 10 is coupled to service nodes 20, 20a, 20b, 20c, . . . and a collector node 30 through a network 40. Each of the service nodes 20, 20a, 20b, 20c, . . . and the collector node 30 may be a physical machine or may be a virtual machine that operates on a physical machine. Each of the service nodes 20, 20a, 20b, 20c, . . . and the collector node 30 may be implemented by a component referred to as a container on a container base.

Each of the service nodes 20, 20a, 20b, 20c, . . . provides various services. Each of the service nodes 20, 20a, 20b, 20c, . . . executes processing for which plural services are caused to cooperate in response to a request by a user and returns the processing result. For example, the service node 20 functions as a gateway and accepts a request from a client computer (diagrammatic representation is omitted) operated by a user to carry out cooperation with a service node with which communication is to be carried out next according to the request. What set of service nodes in the service nodes 20, 20a, 20b, 20c, . . . cooperate differs according to the request by the user. The flow of a series of communication data (or packets for carrying divided data obtained by dividing communication data) transmitted and received between the respective service nodes in response to one request by a user until an acknowledgement to the request is generated is referred to as “data flow.” The communication data may be transmitted and received by the protocol (for example, HTTP, HTTP secure (HTTPS), or the like) of layer 7 in the open system interconnection (OSI) reference model, for example.

The collector node 30 carries out monitoring of processing performance by cooperation of services provided by the service nodes 20, 20a, 20b, 20c, . . . . However, because a large amount of communication data is transmitted and received among the service nodes 20, 20a, 20b, 20c, . . . , the monitoring is carried out with focus on part of data flows as the sampling target. As the data flows of the sampling target, data flows generated every given number of times of request by a user, data flows generated in response to requests by a user at given time intervals, or the like are decided by the service node 20 as the gateway (or another node for which diagrammatic representation is omitted), for example.

For example, the service node 20 inserts given identification information indicating that communication data is the sampling target in the header (HTTP header or the like) of the communication data that belongs to the data flow of the sampling target. This allows another service node that has received the communication data in which the identification information is inserted to determine that the received communication data is the data flow of the sampling target by the identification information. The other service node removes the identification information from the header of the communication data and executes processing by the self-node to generate communication data including the processing result. Then, the other service node adds the identification information to the generated communication data and transfers the communication data to the next service node.

Each of the service nodes 20, 20a, 20b, 20c, . . . transmits a given notification packet to the collector node 30 at the timing when communication data of the sampling target is received, the timing when communication data is transmitted to the next service node, or the like. The notification packet is a packet for notifying the collector node 30 of that the communication data (or packet) of the sampling target has been transferred. The collector node 30 records the reception clock time of each notification packet regarding the data flow of the sampling target and may measure processing performance by cooperation of the series of services corresponding to the data flow of the sampling target based on the time difference in the recorded reception clock time.

At this time, depending on the measured processing performance, the packet corresponding to the data flow of the sampling target is desired to be acquired and analyzed in some cases. This is because the above-described monitoring by the collector node 30 is insufficient for analysis of delay and so forth attributed to the communication path of the network 40 although delay at the application level may be analyzed.

Thus, the packet analysis apparatus 10 provides a function of collecting packets communicated between service nodes and between the respective service nodes and the collector node 30 and estimating a packet group corresponding to the data flow of the sampling target from the collected packets.

A storing unit 11 may be a volatile storing apparatus such as a random access memory (RAM) or a ternary content addressable memory (TCAM) or may be a non-volatile storing apparatus such as a hard disk drive (HDD) or a flash memory. A processing unit 12 may include a central processing unit (CPU), a digital signal processor (DSP), an application specific integrated circuit (ASIC), a field programmable gate array (FPGA), and so forth. The processing unit 12 may be a processor that executes a program. A collection of plural processors (multi-processor) may be included in the term “processor.”

The storing unit 11 stores information on the address of the collector node 30. The information on the address is information on the Internet protocol (IP) address of the collector node 30, for example. The information on the address may include the port number of TCP in addition to the IP address. The storing unit 11 stores packets collected by the processing unit 12. To the collected packets, a timestamp that indicates the clock time of arrival of the packet to the packet analysis apparatus 10 is given.

The processing unit 12 collects packets transmitted among plural nodes including the service nodes 20, 20a, 20b, 20c, . . . (plural first nodes) and the collector node 30 (second node) and stores the packets in the storing unit 11. The service nodes 20, 20a, 20b, 20c, . . . provide services and communicate with each other as described above. The collector node 30 receives the notification packet indicating that the packet corresponding to the data flow of the sampling target has been transferred from each service node as described above.

For example, a given switch (diagrammatic representation is omitted) in the network 40 duplicates packets transmitted and received among the service nodes 20, 20a, 20b, 20c, . . . and between the respective service nodes and the collector node 30. The switch sends the duplicated packets to the packet analysis apparatus 10. The processing unit 12 receives the packets duplicated by the switch and gives information (timestamp) on the present clock time (arrival clock time) to the received packets to store the packets in the storing unit 11.

As one example, the packets stored in the storing unit 11 include a packet group corresponding to data flows f1, f2, and f3 and a notification packet group n1. A sequence diagram Al illustrates the timings of transmission and reception by the respective nodes regarding these packets (transmission/reception timings estimated based on the timestamp given by the packet analysis apparatus 10). The direction from the upper side toward the lower side in the sequence diagram A1 is the positive direction of the time.

The data flow f1 includes a packet group corresponding to requests f11 and f12 and acknowledgements f13 and f14. The request f11 is a request from the service node 20 to the service node 20b. The request f12 is a request from the service node 20b to the service node 20c transmitted in response to the request f11. The acknowledgement f13 is an acknowledgement from the service node 20c to the service node 20b. The acknowledgement f14 is an acknowledgement from the service node 20b to the service node 20.

The data flow f2 includes a packet group corresponding to requests f21, f22, and f23 and acknowledgements f24, f25, and f26. The request f21 is a request from the service node 20 to the service node 20a. The request f22 is a request from the service node 20a to the service node 20b transmitted in response to the request f21. The request f23 is a request from the service node 20b to the service node 20c transmitted in response to the request f22. The acknowledgement f24 is an acknowledgement from the service node 20c to the service node 20b. The acknowledgement f25 is an acknowledgement from the service node 20b to the service node 20a. The acknowledgement f26 is an acknowledgement from the service node 20a to the service node 20.

The data flow f3 includes a packet group corresponding to requests f31, f32, and f33 and acknowledgements f34, f35, and f36. The request f31 is a request from the service node 20 to the service node 20a. The request f32 is a request from the service node 20a to the service node 20b transmitted in response to the request f31. The request f33 is a request from the service node 20b to the service node 20c transmitted in response to the request f32. The acknowledgement f34 is an acknowledgement from the service node 20c to the service node 20b. The acknowledgement f35 is an acknowledgement from the service node 20b to the service node 20a. The acknowledgement f36 is an acknowledgement from the service node 20a to the service node 20.

The notification packet group n1 includes packets n11, n12, n13, and n14. The packet n11 is a notification packet from the service node 20 to the collector node 30. The packet n12 is a notification packet from the service node 20a to the collector node 30. The packet n13 is a notification packet from the service node 20b to the collector node 30. The packet n14 is a notification packet from the service node 20c to the collector node 30.

The processing unit 12 identifies plural notification packets whose destination is the collector node 30 in the collected packets. As described above, information on the address of the collector node 30 is stored in the storing unit 11 in advance. For example, the processing unit 12 refers to a destination IP address included in the IP header of the collected packets and identifies packets having the address of the collector node 30 as the destination address as the notification packets. The destination of the packet may be decided based on a combination of the destination IP address of the packet and a destination port number included in the TCP header of the packet.

For example, the processing unit 12 identifies, as the notification packet, each of the packets n11, n12, n13, and n14, whose destination is the collector node 30, from the collected packets illustrated in the sequence diagram A1.

The processing unit 12 acquires plural transmission source addresses of the identified plural notification packets. For example, the processing unit 12 acquires the transmission source address included in the IP header of the identified notification packet. The notification packet is transmitted by any service node when the packet corresponding to the data flow of the sampling target is transferred. Thus, the transmission source address acquired here represents the address of the service node involved in the transfer of the packet corresponding to the data flow.

For example, the processing unit 12 acquires the address of the service node 20 as the transmission source address of the packet nil. The processing unit 12 acquires the address of the service node 20a as the transmission source address of the packet n12. The processing unit 12 acquires the address of the service node 20b as the transmission source address of the packet n13. The processing unit 12 acquires the address of the service node 20c as the transmission source address of the packet n14.

The processing unit 12 extracts, from the collected packets, plural candidate packets having a set of two addresses in the acquired plural transmission source addresses as the transmission source and the destination. The candidate packet is a candidate for the packet corresponding to the data flow of the sampling target. As described above, the plural transmission source addresses acquired by the processing unit 12 all represent the address of the service node involved in the transfer of the packet corresponding to the data flow of the sampling target. Therefore, it is estimated that there is a possibility that the candidate packet having a set of two addresses in the plural transmission source addresses as the transmission source and the destination is the packet corresponding to the data flow of the sampling target. Meanwhile, it is estimated that the packet having an address other than the plural transmission source addresses as the transmission source or the destination is not the packet corresponding to the data flow of the sampling target (outside the candidates).

For example, for the collected packets illustrated in the sequence diagram A1, the processing unit 12 acquires the address of each of the service nodes 20, 20a, 20b, and 20c. In the respective packets that belong to the data flows f1, f2, and f3, the transmission source and the destination are both equivalent to the address of the service node 20, 20a, 20b, or 20c. Therefore, the respective packets that belong to the data flows f1, f2, and f3 are the candidate packets.

The processing unit 12 decides a set of packets corresponding to the data flow of the sampling target from the extracted plural candidate packets. For example, the processing unit 12 detects the data flows f1, f2, and f3 based on the sets of the transmission source addresses and the destination addresses of the candidate packets and the time series of the candidate packets. Then, the processing unit 12 deems, as candidate flows, the data flows in which the four service nodes as the transmission sources of the packets n11, n12, n13, and n14 are involved in the data flows f1, f2, and f3, and deems the data flow other than them as the data flow outside the candidates. In the example of the sequence diagram A1, the data flow f1 is deemed as the data flow outside the candidates because the number of involved service nodes is three.

If the number of candidate flows is one, the processing unit 12 decides the candidate flow as the data flow of the sampling target and decides the set of packets corresponding to the candidate flow as the set of packets corresponding to the data flow of the sampling target.

On the other hand, if plural candidate flows exist, the processing unit 12 narrows down the candidates through comparison between a first timestamp of the packets n11, n12, n13, and n14 (respective notification packets) and a second timestamp of the packets that belong to the candidate flow. For example, the processing unit 12 decides, as the data flow of the sampling target, the candidate flow with which the time difference between the first timestamp and the second timestamp is short (corresponding to the second timestamp closest to the first timestamp) in the plural candidate flows. Then, the processing unit 12 decides the set of packets corresponding to the candidate flow decided as the data flow of the sampling target as the set of packets corresponding to the data flow of the sampling target.

An arbitrary method may be used as the method for obtaining the time interval between the first timestamp and the second timestamp. For example, the processing unit 12 may obtain the time difference between the first timestamp of a representative packet (for example, first packet) in the notification packet group n1 and the second timestamp of a representative packet (for example, first packet) in the respective packets of the candidate flow. The processing unit 12 may obtain the time difference in such a manner as to employ a representative value of the timestamp of the respective notification packets of the notification packet group n1 (for example, central clock time) as the first timestamp and employ a representative value of the timestamp of the respective packets of the candidate flow as the second timestamp.

In the example of the sequence diagram A1, the processing unit 12 obtains a first time difference based on the timestamp of each packet that belongs to the data flow f2, which is the candidate flow, and the timestamp of each notification packet. Furthermore, the processing unit 12 obtains a second time difference based on the timestamp of each packet that belongs to the data flow f3, which is the candidate flow, and the timestamp of each notification packet. The first time difference is shorter than the second time difference. The processing unit 12 compares the first time difference and the second time difference and identifies the data flow f2 corresponding to the first time difference, which is shorter, as the data flow of the sampling target. Then, the processing unit 12 decides the set of packets corresponding to the data flow f2 (set of packets configuring the requests f21, f22, and f23 and the acknowledgements f24, f25, and f26) as the set of packets corresponding to the data flow of the sampling target.

According to the packet analysis apparatus 10, packets transmitted among plural nodes including plural first nodes that provide services and communicate with each other and a second node that receives the notification packet indicating that the packet corresponding to the data flow of the sampling target has been transferred from each of the plural first nodes are collected. In the collected packets, plural notification packets whose destination is the second node are identified. Plural transmission source addresses of the identified plural notification packets are acquired. Plural candidate packets having a set of two addresses in the acquired plural transmission source addresses as the transmission source and the destination are extracted from the collected packets. The set of packets corresponding to the data flow of the sampling target is decided from the extracted plural candidate packets.

This may enhance the speed of estimation of packets that belong to the data flow of the sampling target. For example, the set of packets that belong to the data flow of the sampling target may be decided without analyzing information on layer 7 (application layer) such as the HTTP header and the speed of the processing may be enhanced compared with the case of analyzing information on layer 7. Furthermore, it becomes possible to rapidly start analysis of the cause of processing delay in the network 40 and so forth due to analysis of IP (layer 3), TCP (layer 4), and so forth with use of the set of packets that belong to the data flow of the sampling target.

In the following, a more specific information processing system will be exemplified and functions of the packet analysis apparatus 10 will be described in more detail.

### Second Embodiment

Next, a second embodiment will be described.

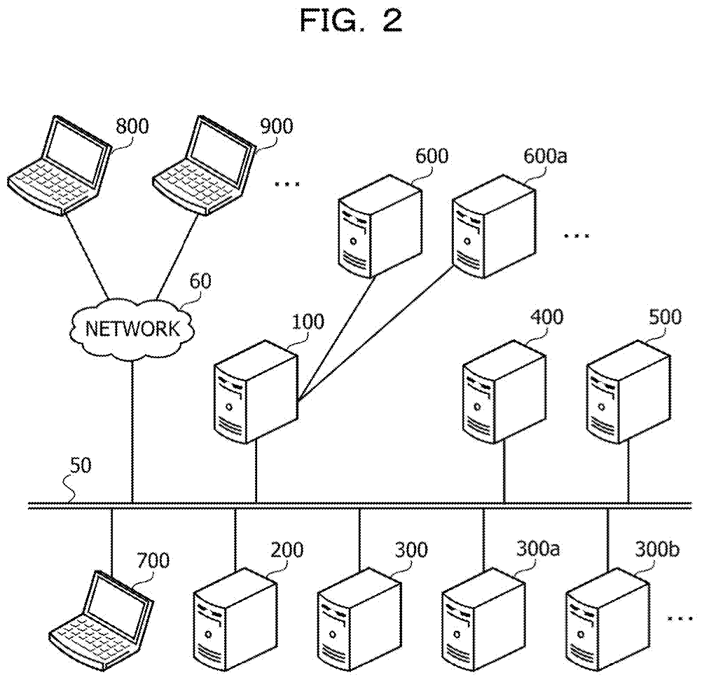

FIG. 2 is a diagram illustrating an example of an information processing system of the second embodiment.

The information processing system of the second embodiment includes an analysis apparatus 100, a gateway 200, servers 300, 300a, 300b, . . . , a span manager 400, a span collector 500, store servers 600, 600a, . . . , and a management terminal 700. The analysis apparatus 100, the gateway 200, the servers 300, 300a, 300b, . . . , the span manager 400, the span collector 500, the store servers 600, 600a, . . . , and the management terminal 700 are coupled to a network 50. The network 50 is a local area network (LAN) in a data center or the like, for example. The network 50 is coupled to a network 60. The network 60 is a wide area network (WAN), the Internet, or the like, for example. Clients 800, 900, . . . are coupled to the network 60.

In the information processing system of the second embodiment, various services are operated in units referred to as containers on a container base in each of the servers 300, 300a, 300b, . . . . It may also be said that the container is an instance of the service. One group of containers (referred to as pod (POD)) corresponds to one service. The structure to deploy the service (or application that provides the service) in each server independently by the containers and enable cooperation of the services by coupling the containers as above is referred to as micro-service architecture. The user operates the clients 800, 900, . . . to use the services provided by the information processing system.

The container may be thought of as one example of the service nodes 20, 20a, 20b, 20c, . . . (first nodes) of the first embodiment. However, the main entity of provision of services may be a physical machine or a virtual machine. In the case of considering a physical machine or a virtual machine as the main entity of provision of services, the physical machine or virtual machine may be thought of as one example of the service nodes 20, 20a, 20b, 20c, . . . (first nodes) of the first embodiment.

The analysis apparatus 100 is a server computer that carries out monitoring of functions provided by the information processing system and analysis of the performance. The analysis apparatus 100 collects packets communicated between containers in the information processing system and carries out monitoring of functions provided by the information processing system and analysis of the performance based on the collected packets. The analysis apparatus 100 is one example of the packet analysis apparatus 10 of the first embodiment.

The analysis apparatus 100 may be implemented by a general-purpose server computer as described above or may be implemented by a programmable apparatus in which logic may be implemented by a FPGA or the like. The analysis apparatus 100 may be referred to as aggregator.

The gateway 200 is a server computer that receives a request from the client 800, 900, . . . and transmits a request to a container deployed on the server 300, 300a, 300b, . . . in response to the request. Functions of the gateway 200 may be implemented by a virtual machine or a container on a server computer (physical machine).

The servers 300, 300a, 300b, . . . are server computers that each include a container base and cause services to operate in units of POD on the container base. One or more services may operate by one or more PODs on one server.

The span manager 400 is a server computer that controls the sampling timing of the data flow. In the information processing system with a comparatively-large scale, the number of data flows is large and therefore the data flow of a tracing target is decided by a given sampling algorithm, for example. The rate of sampling is set in the span manager 400 in advance by the system administrator. The span manager 400 decides what ordinal number the request deemed as the sampling target has in order of acceptance of the requests from the clients 800, 900, . . . , and notifies the gateway 200 of information indicating the request of the sampling target. Functions of the span manager 400 may be implemented by a virtual machine or a container on a server computer (physical machine).

The span collector 500 is a server computer that collects information relating to the span. For example, when the request of the sampling target is transferred to a container on any server by the gateway 200 and communication between containers occurs, the span collector 500 receives information on the span from the gateway 200 or the server that operates the container. The span is a data unit including information on the name of a service and the relationship with another service that calls the service (alternatively, the relationship may be a relationship with another service called by the service). The span may include information on the processing start clock time, the execution time, and so forth of the service. The span is identified based on a span ID. The span ID is given for each span by each server. Functions of the span collector 500 may be implemented by a virtual machine or a container on a server computer (physical machine). The span collector 500 is one example of the collector node 30 (second node) of the first embodiment.

The store servers 600, 600a, . . . are server computers that store packets collected by the analysis apparatus 100. The store servers 600, 600a, . . . may be a network attached storage (NAS) or may be a storage apparatus coupled to the analysis apparatus 100 by an interface such as a fibre channel (FC).

The management terminal 700 is a client computer operated by the system administrator. The management terminal 700 acquires the analysis result of packets by the analysis apparatus 100 and causes a display of the management terminal 700 to display the analysis result. The system administrator carries out operation management of the information processing system based on the analysis result displayed on the display of the management terminal 700.

The clients 800, 900, . . . are client computers operated by the user. The clients 800, 900, . . . each transmit a request for processing in the information processing system to the gateway 200 through the network 60. The clients 800, 900, . . . each receive an acknowledgement to the request from the gateway 200.

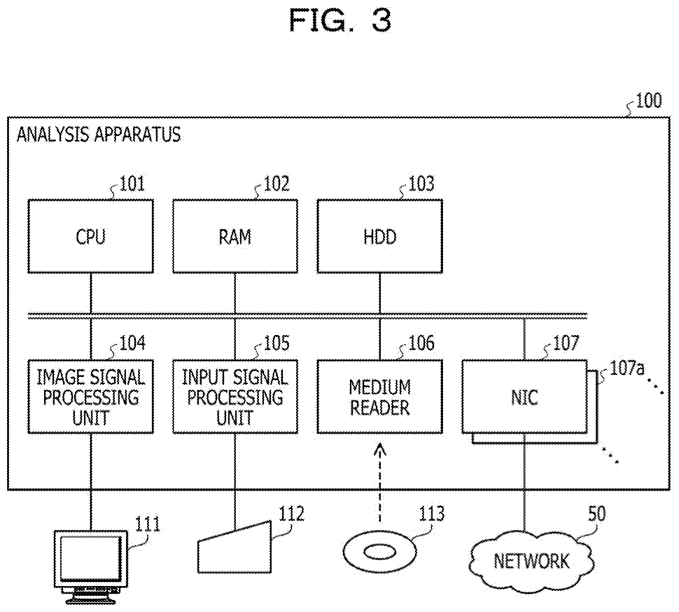

FIG. 3 is a block diagram illustrating a hardware example of an analysis apparatus.

The analysis apparatus 100 includes a CPU 101, a RAM 102, an HDD 103, an image signal processing unit 104, an input signal processing unit 105, a medium reader 106, and network interface cards (NICs) 107, 107a, . . . . The CPU 101 corresponds to the processing unit 12 of the first embodiment. The RAM 102 or the HDD 103 corresponds to the storing unit 11 of the first embodiment.

The CPU 101 is a processor that executes a command of a program. The CPU 101 loads at least part of a program or data stored in the HDD 103 into the RAM 102 and executes the program. The CPU 101 may include plural processor cores. The analysis apparatus 100 may include plural processors. The processing described below may be executed in parallel by using plural processors or processor cores. A collection of plural processors is often referred to as “multi-processor” or simply “processor.”

The RAM 102 is a volatile semiconductor memory that temporarily stores the program executed by the CPU 101 or the data used by the CPU 101 for arithmetic operation. The analysis apparatus 100 may include other kinds of memory than the RAM and may include plural memories.

The HDD 103 is a non-volatile storing apparatus that stores an operating system (OS), programs of a software such as a middleware and an application software, and data. The analysis apparatus 100 may include other kinds of a storing apparatus, such as a flash memory and a solid state drive (SSD), and may include plural non-volatile storing apparatuses.

The image signal processing unit 104 outputs an image to the display 111 coupled to the analysis apparatus 100 in accordance with a command from the CPU 101. As the display 111, arbitrary kinds of displays such as a cathode ray tube (CRT) display, a liquid crystal display (LCD), a plasma display, and an organic electro-luminescence (OEL) display may be used.

The input signal processing unit 105 acquires an input signal from the input device 112 coupled to the analysis apparatus 100 and outputs it to the CPU 101. As the input device 112, pointing devices such as a mouse, a touch panel, a touch pad, and a trackball, a keyboard, a remote controller, a button switch, and so forth may be used. Plural kinds of input devices may be coupled to the analysis apparatus 100.

The medium reader 106 is a reading apparatus that reads programs and data recorded on a recording medium 113. As the recording medium 113, for example, a magnetic disk, an optical disc, a magneto-optical disk (MO), a semiconductor memory, and so forth may be used. A flexible disk (FD) and an HDD are included in the magnetic disk. A compact disc (CD) and a digital versatile disc (DVD) are included in the optical disc.

The medium reader 106 copies a program or data read from the recording medium 113 to another recording medium such as the RAM 102 or the HDD 103, for example. The read program is executed by the CPU 101, for example. The recording medium 113 may be a portable recording medium and is often used for distribution of a program or data. The recording medium 113 and the HDD 103 are often referred to as a computer-readable recording medium.

The NICs 107, 107a, . . . are interfaces that are coupled to the network 50 and carry out communication with another computer through the network 50. The NICs 107, 107a, are coupled to a communication apparatus such as a switch and a router by a cable, for example.

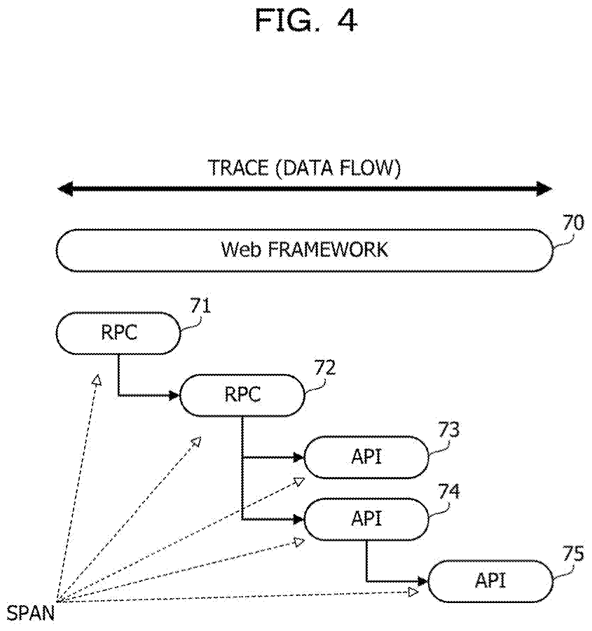

FIG. 4 is a diagram illustrating an example of spans.

As one example, communication between services is carried out by using the HTTP (however, another protocol may be used). A Web framework 70 is one unit of functions implemented by cooperation between services in response to a certain request from the client 800, 900, . . . . A series of communication between services in the Web framework 70 is referred to as one trace. One data flow (or flow) corresponds to one trace. For example, the Web framework 70 is implemented by cooperation of services 71, 72, 73, 74, and 75. The services 71 and 72 are remote procedure call (RPC) services. The services 73, 74, and 75 are services that provide a given application programming interface (API) (for example, Web services).

The service 71 calls the service 72. The service 72 calls the services 73 and 74. The service 74 calls the service 75. Given functions are implemented by cooperation among these services. As described above, the span is defined by a certain service and the relationship of calling from the service to another service. For example, a first span represents the relationship in which the service 72 is called from the service 71. Furthermore, for example, a second span represents the relationship in which the service 73 is called from the service 72. In this case, the first span generates the second span (alternatively, the first span serves as the premise of the second span). Therefore, there is the parent-child relationship in which the first span is defined as the parent span and the second span is defined as the child span.

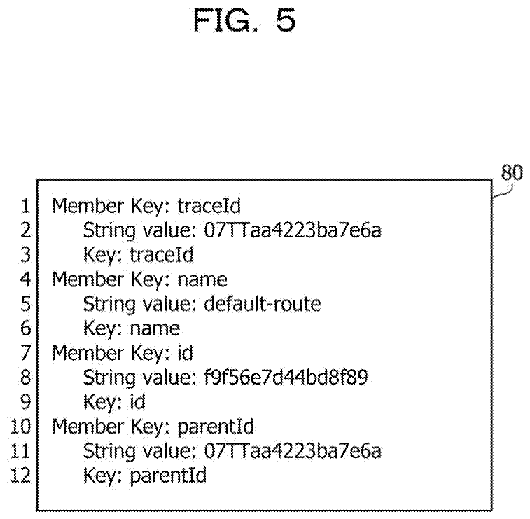

FIG. 5 is a diagram illustrating an example of trace information added to an HTTP header.

Trace information 80 is added to the H I I P header of communication data of a data flow of a sampling target by the gateway 200.

Information on “traceId” is represented on the first row to the third row of the trace information 80. “traceId” is identification information (trace ID) of the data flow (trace) of the sampling target. The setting value of “String value” on the second row indicates the specific value of the trace ID.

Information on “name” is represented on the fourth row to the sixth row of the trace information 80. “name” is the service name corresponding to a span. The setting value of “String value” on the fifth row indicates the specific value of the service name.

Information on “id” is represented on the seventh row to the ninth row of the trace information 80. “id” is identification information (span ID) of the span. The setting value of “String value” on the eighth row indicates the specific value of the span ID.

Information on “parentId” is represented on the tenth row to the twelfth row of the trace information 80. “parentId” is identification information (parent span ID) of the span of the call source (parent span) of the span indicated by id. The setting value of “String value” on the eleventh row indicates the specific value of the parent span ID.

When receiving a request of the sampling target from the client 800, 900, . . . , the gateway 200 gives the trace ID and the span ID corresponding to the self-service to the communication data corresponding to the request. Suppose that the gateway 200 gives the same value as the trace ID as the parent span ID (because the parent span does not exist when the gateway 200 receives the request).

The servers 300, 300a, 300b, . . . also each add information on the format similar to the trace information 80 to communication data received from the gateway 200 or another server. The servers 300, 300a, 300b, . . . set the values of “name,” “id,” and “parentId” according to the service in the self-server in the trace information 80.

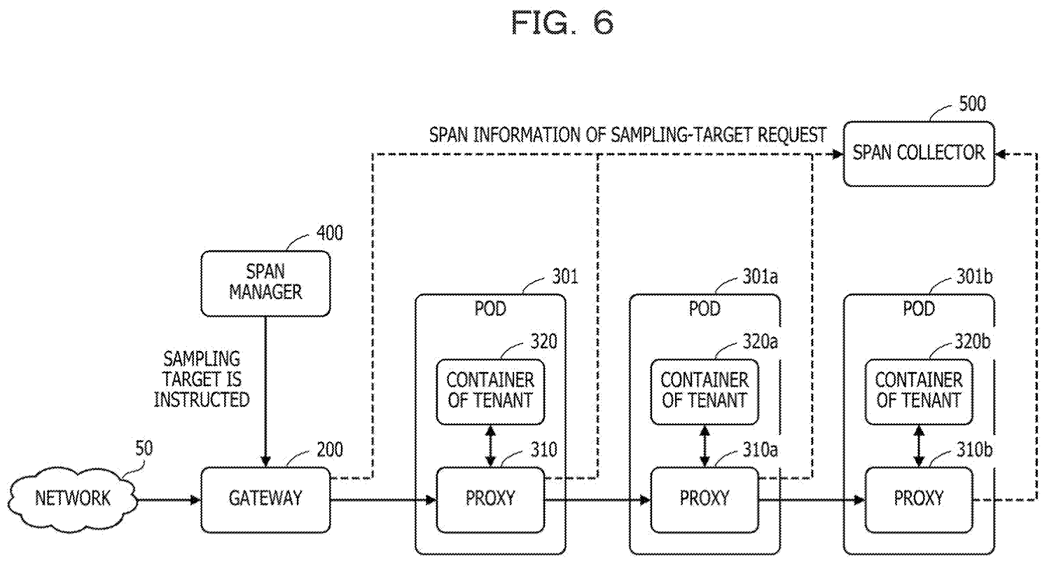

FIG. 6 is a diagram illustrating an example of collection of span information by a span collector.

The span manager 400 notifies the gateway 200 of information indicating a request of the sampling target (sampling-target request). For example, the span manager 400 may count the number of requests accepted by the gateway 200 and decide the sampling target according to the counted number. Alternatively, the span manager 400 may measure the elapsed time from the clock time of previous notification of the sampling target and decide the sampling target based on the elapsed time.

The gateway 200 adds trace information (for example, trace information 80) to the HTTP header for a first sampling-target request received from the client 800, for example. The gateway 200 transmits the first sampling-target request to which the trace information is added to the server (for example, server 300) that processes the request.

The server 300 (diagrammatic representation is omitted) includes a POD 301 of a tenant. The POD 301 includes a proxy 310 and a container 320. The server 300a (diagrammatic representation is omitted) includes a POD 301a of a tenant. The POD 301a includes a proxy 310a and a container 320a. The server 300b (diagrammatic representation is omitted) includes a POD 301b of a tenant. The POD 301b includes a proxy 310b and a container 320b.

Each of the PODs 301, 301a ,and 301b is a group of containers that provide a given service. Each of the PODs 301, 301a ,and 301b includes one or more containers. The service at the previous stage of the POD 301 is a gateway service in the gateway 200. The service at the subsequent stage of the POD 301 is a service of the POD 301a. The service at the previous stage of the POD 301a is a service of the POD 301. The service at the subsequent stage of the POD 301a is a service of the POD 301b. The service at the previous stage of the POD 301b is the service of the POD 301a.

Each of the proxies 310, 310a, and 310b relays communication between the PODs. Each of the proxies 310, 310a, and 310b receives a request from the POD (or proxy) at the previous stage and transfers the request to the self-POD (container corresponding to the self-proxy) to transmit the request accepted from the self-POD to the POD (or proxy) at the subsequent stage. Furthermore, when receiving an acknowledgement from the POD (or proxy) at the subsequent stage, each of the proxies 310, 310a, and 310b transfers the acknowledgement to the self-container and transmits an acknowledgement accepted from the self-POD to the POD (or proxy) at the previous stage. The proxies 310, 310a, and 310b may be implemented by a container referred to as sidecar, for example. The sidecar is an auxiliary container that accompanies the main container in the self-POD.

When receiving the first sampling-target request to which the trace information is added from the gateway 200, the proxy 310 removes the trace information from the first sampling-target request and transfers the first sampling-target request to the container 320. When accepting a second sampling-target request to the service at the subsequent stage according to the first sampling-target request from the container 320, the proxy 310 adds the trace information to the second sampling-target request and transmits the second sampling-target request to the proxy 310a.

When receiving the second sampling-target request to which the trace information is added from the proxy 310, the proxy 310a removes the trace information from the second sampling-target request and transfers the second sampling-target request to the container 320a. When accepting a third sampling-target request to the service at the subsequent stage according to the second sampling-target request from the container 320a, the proxy 310a adds the trace information to the third sampling-target request and transmits the third sampling-target request to the proxy 310b.

When receiving the third sampling-target request to which the trace information is added from the proxy 310a, the proxy 310b removes the trace information from the third sampling-target request and transfers the third sampling-target request to the container 320b. When accepting an acknowledgement according to the third sampling-target request from the container 320b, the proxy 310b transmits the acknowledgement to the proxy 310a. The acknowledgement traces the PODs in reverse order of the transmission order and is transferred to the client of the request source through the gateway 200.

When receiving the sampling-target request instructed by the span manager 400, the gateway 200 transmits information on the span (span information) corresponding to the gateway service provided by the gateway 200 to the span collector 500. When receiving the sampling-target request to which the trace information is added, the proxies 310, 310a, and 310b transmit the span information corresponding to the service provided by the self-POD to the span collector 500. In the span collector 500, analysis of the application level may be carried out regarding the data flow of the sampling target based on the span information thus collected.

Meanwhile, communication quality and so forth at the packet level in the communication path and so forth are often measured by carrying out analysis of a lower layer (for example, layer 3, layer 4, or the like of an OSI reference model) regarding the data flow of the sampling target. For this purpose, the analysis apparatus 100 collects duplicates of packets transmitted and received among the gateway 200 and the servers 300, 300a, 300b, . . . from a given switch that belongs to the network 50.

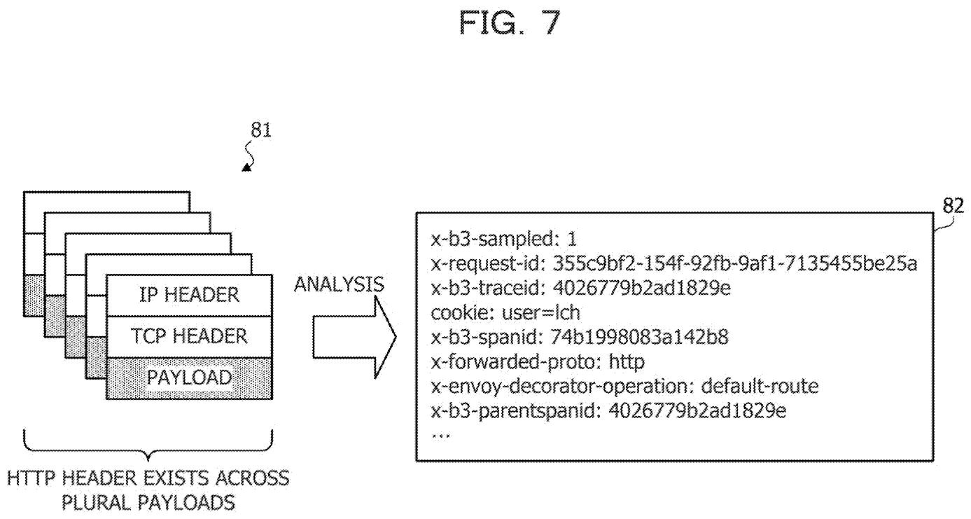

FIG. 7 is a diagram illustrating an example of an HTTP header for a packet group.

A packet group 81 includes information equivalent to an HTTP header 82. One packet includes an IP header, a TCP header, and a payload. The information on the HTTP header 82 exists across plural payloads of plural packets included in the packet group 81. For example, the payload of each packet includes part of the information on the HTTP header 82.

For example, it is conceivable that the analysis apparatus 100 identifies the packet corresponding to the data flow of the sampling target from collected all packets. In this case, the analysis apparatus 100 analyzes the packet group 81 and acquires the H 11 P header 82. Then, with reference to the HTTP header 82, the analysis apparatus 100 may check whether a trace ID, a span ID, and a parent span ID corresponding to the data flow of the sampling target are included. However, when analysis at the application level based on the HTTP header 82 is carried out, the analysis takes a long time and identifying the packet is delayed. For this reason, it is difficult to carry out monitoring in real time, for example.

Thus, the analysis apparatus 100 gives a timestamp to received packets (duplicated packets) and records the packets. The analysis apparatus 100 identifies the packet corresponding to the data flow of the sampling target based on the timestamp of the packet and information on a destination IP address, a transmission source IP address, a destination port number, and a transmission source port number included in the packet.

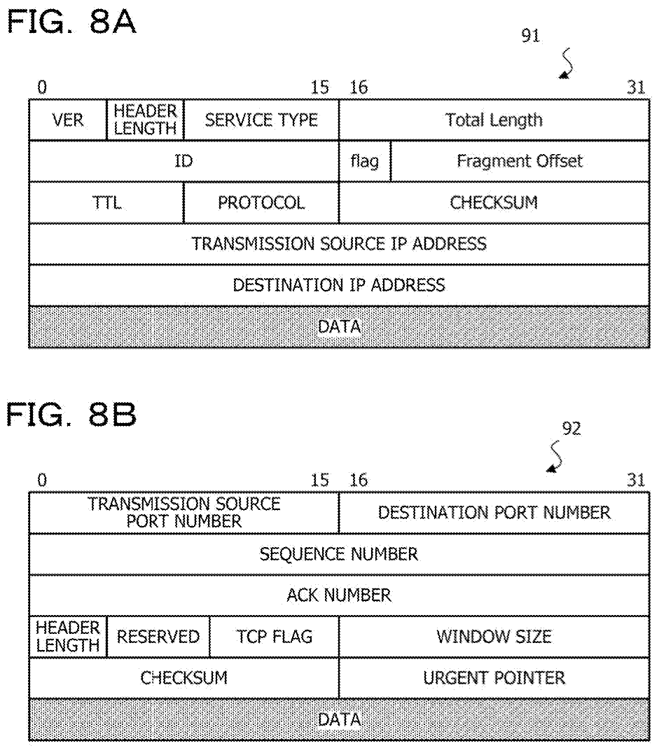

FIG. 8 is a diagram illustrating examples of headers included in a packet.

FIG. 8A exemplifies an IP header 91 of the packet. The IP header 91 includes fields of a protocol, a transmission source IP address, and a destination IP address. The protocol is information for identifying upper-layer protocols (TCP, user datagram protocol (UDP), and so forth). The transmission source IP address is the IP address of the transmission source node of the packet. The destination IP address is the IP address of the destination node of the packet.

FIG. 8B exemplifies a TCP header 92 of the packet. The TCP header 92 includes fields of a transmission source port number and a destination port number. The transmission source port number is information corresponding to the service that has processed the packet at the transmission source node of the packet. The destination port number is information corresponding to the service that processes the packet at the destination node of the packet.

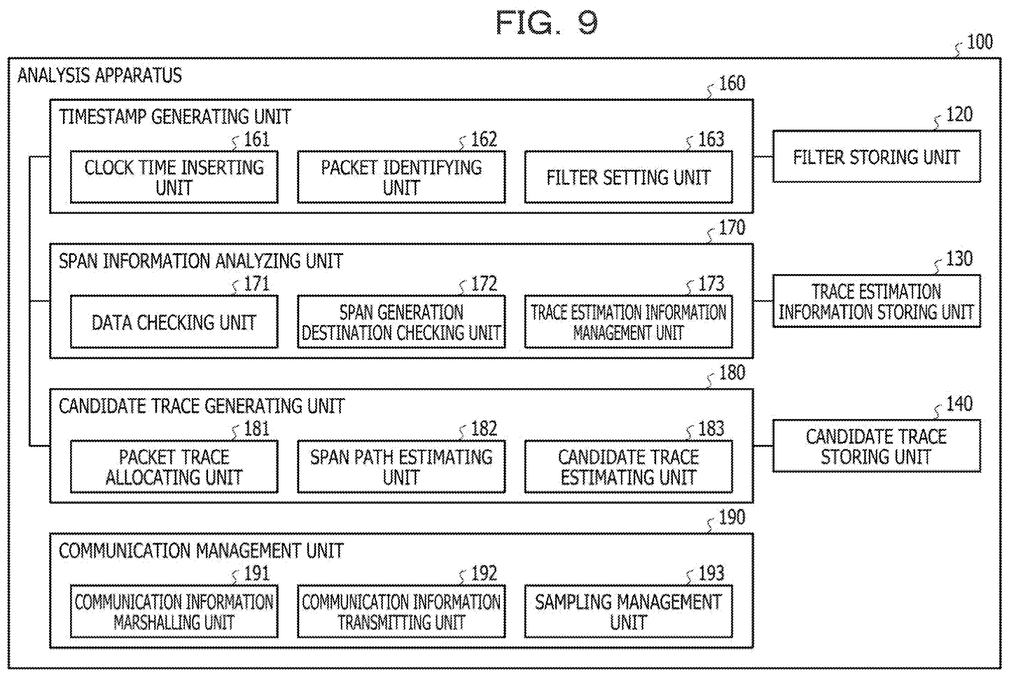

FIG. 9 is a block diagram illustrating a function example of an analysis apparatus.

The analysis apparatus 100 includes a filter storing unit 120, a trace estimation information storing unit 130, a candidate trace storing unit 140, a timestamp generating unit 160, a span information analyzing unit 170, a candidate trace generating unit 180, and a communication management unit 190.

The filter storing unit 120, the trace estimation information storing unit 130, and the candidate trace storing unit 140 are implemented by using a storage area of the RAM 102 and the HDD 103. The timestamp generating unit 160, the span information analyzing unit 170, the candidate trace generating unit 180, and the communication management unit 190 are implemented through execution of a program stored in the RAM 102 by the CPU 101.

The filter storing unit 120 stores a filter table. The filter table is information for narrowing down the packets of the collection target. The packets of the collection target are narrowed down to packets whose transmission source and destination are addresses corresponding to the respective PODs and the span collector by the filter table.

The trace estimation information storing unit 130 stores a trace estimation information table. The trace estimation information table is information that represents an IP address for estimating the data flow (trace) of the sampling target.

The candidate trace storing unit 140 stores a candidate trace management table and a span management table. The candidate trace management table is information that represents candidates for the data flow (trace) of the sampling target. The span management table is information that represents spans that belong to the candidates for the data flow of the sampling target.

The timestamp generating unit 160 receives packets duplicated by the switch that belongs to the network 50. The timestamp generating unit 160 includes a clock time inserting unit 161, a packet identifying unit 162, and a filter setting unit 163.

The clock time inserting unit 161 gives a timestamp indicating the reception clock time to the received packets.

The packet identifying unit 162 determines whether to drop (discard) the received packet or to deem the packet as the target of processing by the span information analyzing unit 170 based on the filter table stored in the filter storing unit 120. The filter setting unit 163 generates the filter table based on information on a filter acquired by the communication management unit 190 and stores the filter table in the filter storing unit 120.

The span information analyzing unit 170 generates the trace estimation information table based on packets after the filter by the timestamp generating unit 160 and stores the trace estimation information table in the trace estimation information storing unit 130. The span information analyzing unit 170 includes a data checking unit 171, a span generation destination checking unit 172, and a trace estimation information management unit 173.

The data checking unit 171 checks whether or not a packet from a POD is a DATA packet. For example, by checking the TCP flag in the TCP header 92 of the packet or the sequence number, the ACK number, or the like, the data checking unit 171 may check whether or not the packet is a DATA packet.

The span generation destination checking unit 172 checks the transmission destination IP address of the DATA packet identified by the data checking unit 171 and identifies the DATA packet whose transmission destination IP address is the IP address of the span collector 500 to supply the DATA packet to the trace estimation information management unit 173.

The trace estimation information management unit 173 records the transmission source IP address of the DATA packet acquired from the span generation destination checking unit 172 in the trace estimation information table stored in the trace estimation information storing unit 130 together with the timestamp.

The candidate trace generating unit 180 generates the candidate trace management table and the span management table and stores them in the candidate trace storing unit 140. The candidate trace generating unit 180 includes a packet trace allocating unit 181, a span path estimating unit 182, and a candidate trace estimating unit 183.

The packet trace allocating unit 181 generates the candidate trace management table and the span management table based on the respective packets and stores them in the candidate trace storing unit 140.

The span path estimating unit 182 identifies the parent-child relationship of spans that belong to traces registered in the candidate trace management table from communication information of packets (transmission source IP address/transmission source port number and destination IP address/destination port number). The span path estimating unit 182 records the communication information of the spans that belong to the traces in the span management table.

The candidate trace estimating unit 183 estimates the packets corresponding to the data flow of the sampling target in the data flows managed by the candidate trace management table and the span management table based on the trace estimation information table.

The communication management unit 190 carries out communication with another computer. The communication management unit 190 includes a communication information marshalling unit 191, a communication information transmitting unit 192, and a sampling management unit 193.

The communication information marshalling unit 191 acquires communication information such as an IP address, a TCP port number, and so forth of the PODs and the span collector 500 from the information on the filter.

The communication information transmitting unit 192 supplies the communication information acquired by the communication information marshalling unit 191 to the candidate trace generating unit 180.

The sampling management unit 193 estimates a period in which sampling of the data flow is carried out. The sampling management unit 193 controls the timestamp generating unit 160, the span information analyzing unit 170, and the candidate trace generating unit 180 to identify the packets corresponding to the data flow of the sampling target from packets collected in the estimated period.

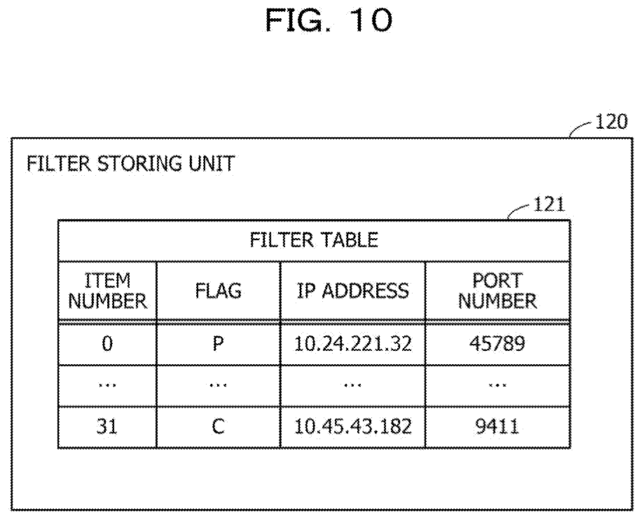

FIG. 10 is a diagram illustrating an example of a filter table.

A filter table 121 includes items of an item number, a flag, an IP address, and a port number.

In the item of the item number, a number for identifying the record is registered. In the item of the flag, a flag for identifying whether the relevant record is information on a POD or information on the span collector 500 is registered. A flag “P” represents the POD. A flag “C” represents the span collector 500. In the item of the IP address, the IP address of the relevant node (POD or span collector 500) is registered. In the item of the port number, the port number of the relevant node (POD or span collector 500) is registered.

For example, in the filter table 121, a record is registered in which the item number is “0,” the flag is “P,” the IP address is “10.24.221.32,” and the port number is “45789.”

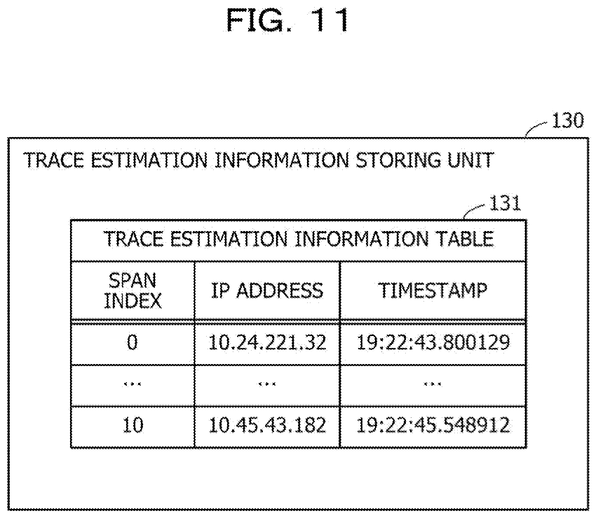

FIG. 11 is a diagram illustrating an example of a trace estimation information table.

A trace estimation information table 131 includes items of a span index, an IP address, and a timestamp.

In the item of the span index, a span index that is identification information for identifying the record is registered. The span index begins from “0” and is incremented every time a record is added. In the item of the IP address, the transmission source IP address acquired from a packet whose destination is the span collector 500 is registered. In the item of the timestamp, a timestamp that represents the clock time when the packet whose destination is the span collector 500 has been received is registered.

For example, in the trace estimation information table 131, a record is registered in which the span index is “0,” the IP address is “10.24.221.32,” and the timestamp is “19:22:43.800129.”

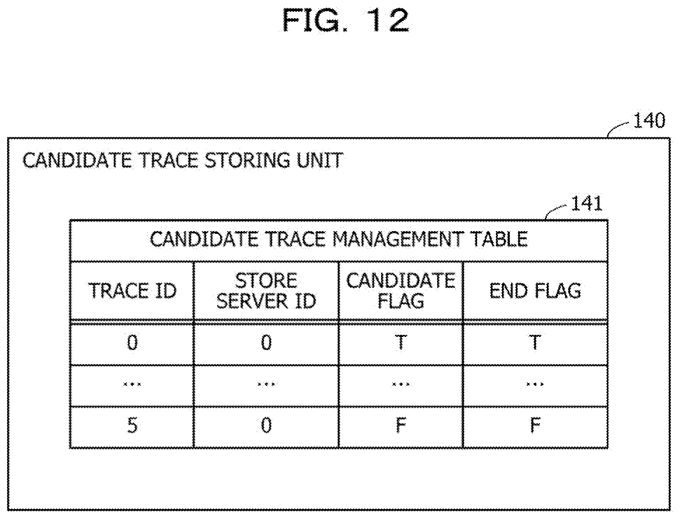

FIG. 12 is a diagram illustrating an example of a candidate trace management table.

A candidate trace management table 141 includes items of a trace ID, a store server ID, a candidate flag, and an end flag.

In the item of the trace ID, a trace ID that is identification information of the trace (data flow) is registered. In the item of the store server ID, identification information of the store servers 600, 600a, . . . as the saving destination of a packet corresponding to the trace ID is registered. In the item of the candidate flag, a candidate flag indicating whether or not the relevant data flow is the data flow of the sampling target is registered. A candidate flag “T (True)” represents that the relevant data flow is the data flow of the sampling target. A candidate flag “F (False)” represents that the relevant data flow is not the data flow of the sampling target. The initial value of the item of the candidate flag is “F.” In the item of the end flag, an end flag indicating whether or not the relevant data flow has ended. “Data flow has ended” represents that a FIN packet has been transmitted to the client of the request source. An end flag “T” represents that the data flow has ended. An end flag “F” represents that the data flow has not ended. The initial value of the end flag is “F.”

For example, in the candidate trace management table 141, a record is registered in which the trace ID is “0,” the store server ID is “0,” the candidate flag is “T,” and the end flag is “T.”

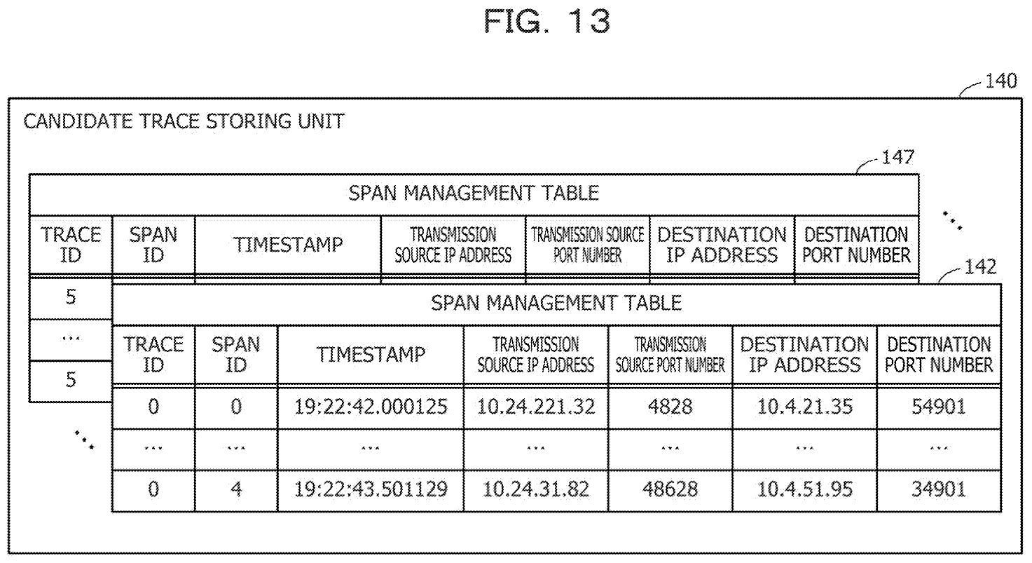

FIG. 13 is a diagram illustrating an example of span management tables.

Span management tables 142, . . . 147 are generated for each trace ID of the candidate trace management table 141. Although description will be made through exemplifying the span management table 142 mainly in the following, the other span management tables also have similar data structure.

The span management table 142 includes items of a trace ID, a span ID, a timestamp, a transmission source IP address, a transmission source port number, a destination IP address, and a destination port number.

In the item of the trace ID, the trace ID is registered. In the item of the span ID, a number to identify the record is registered. The span ID begins from “0” and is incremented every time a record is added to the span management table 142. In the item of the timestamp, a timestamp that represents the clock time when the packet corresponding to the relevant record has been received is registered. In the item of the transmission source IP address, the transmission source IP address of the packet is registered. In the item of the transmission source port number, the transmission source port number of the packet is registered. In the item of the destination IP address, the destination IP address of the packet is registered. In the item of the destination port number, the destination port number of the packet is registered.

For example, in the span management table 142, a record is registered in which the trace ID is “0,” the span ID is “0,” the timestamp is “19:22:42.000125,” the transmission source IP address is “10.24.221.32,” the transmission source port number is “4828,” the destination IP address is “10.4.21.35,” and the destination port number is “54901.”

Furthermore, according to the span management table 142, it turns out that five spans whose span ID is “0” to “4” belong to the data flow with the trace ID “0.” In a certain data flow, the destination IP address and the destination port number corresponding to a certain span ID become the transmission source IP address and the transmission source port number corresponding to the next span ID.

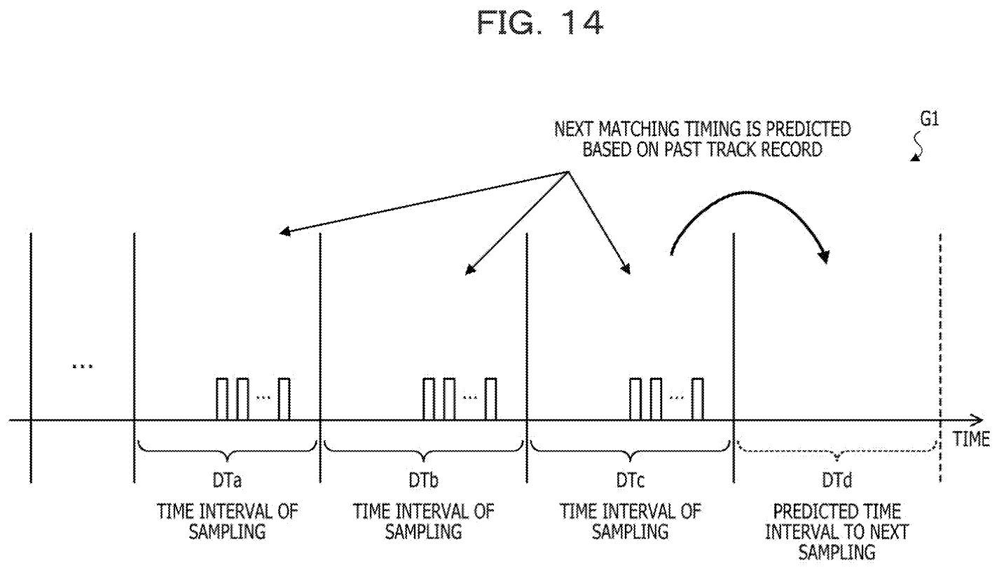

FIG. 14 is a diagram illustrating a prediction example of matching timing.

A graph G1 represents a prediction example of matching timing by the sampling management unit 193. For example, the sampling management unit 193 learns the sampling interval of the data flow and predicts the time interval to the next sampling to use the clock time after the elapse of the predicted time interval from the immediately-previous sampling clock time as the matching timing of the span. For example, the sampling management unit 193 predicts a time interval ΔTd to the next sampling (next matching timing) based on a track record of past time intervals ΔTa, ΔTb, and ΔTc at which sampling of the data flow has been carried out. For the prediction by the sampling management unit 193, a moving-average method or an analysis method based on autoregressive model, autoregressive moving-average model, and so forth may be used. It is conceivable that the sampling management unit 193 employs given periods before and after the predicted matching timing as a target period of packet collection (span matching period), for example.

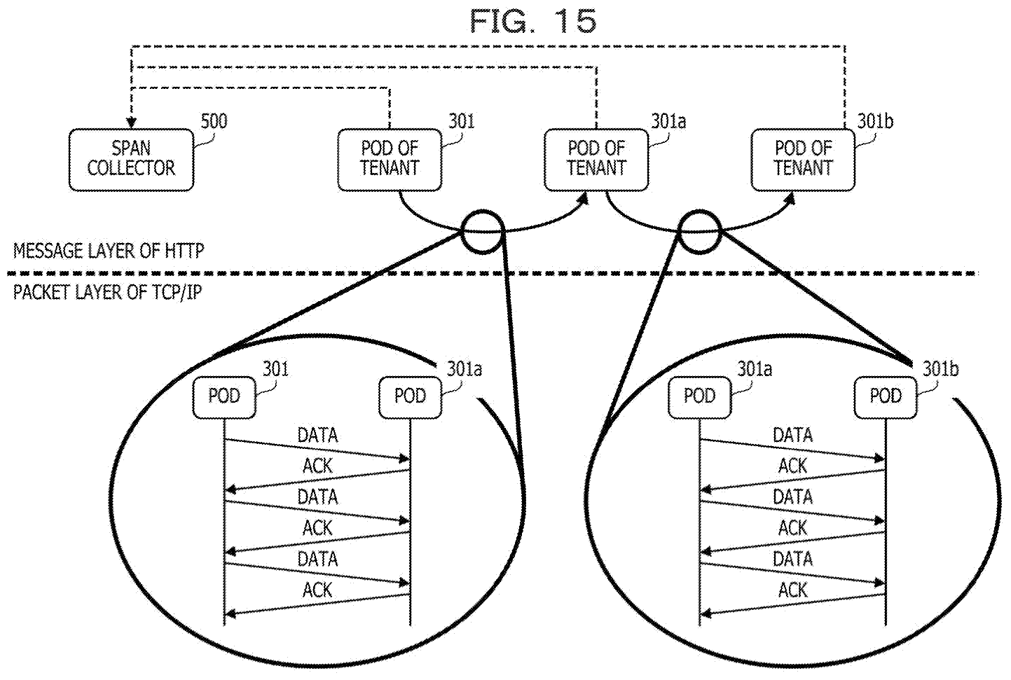

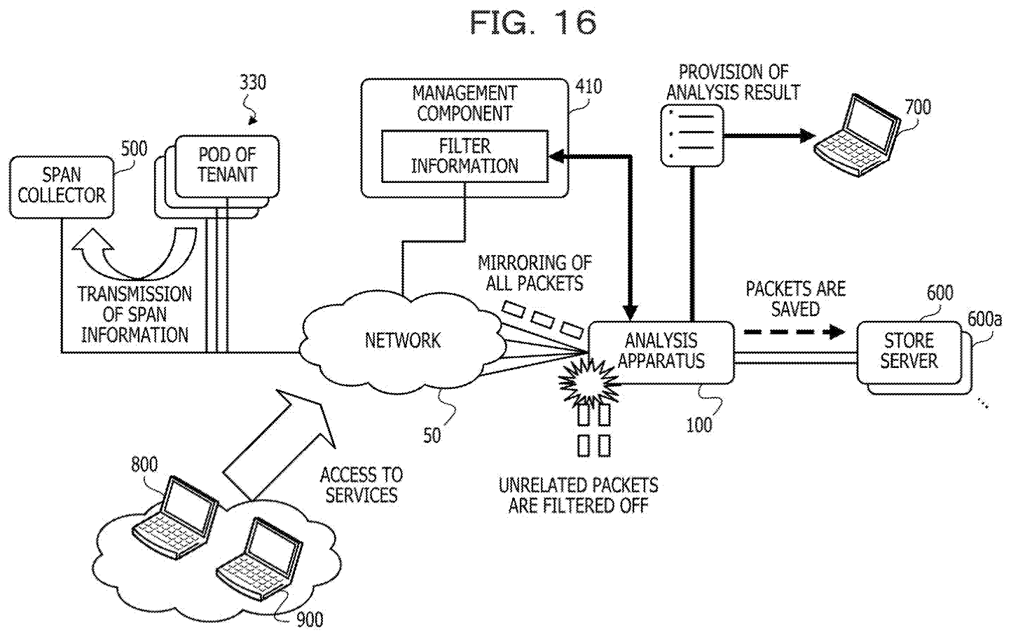

FIG. 15 is a diagram illustrating a relationship between layers.

In FIG. 15, a message layer of the H11P and a packet layer of the TCP/IP are exemplified. For example, the POD 301 transmits communication data to the POD 301a based on the HTTP. For this purpose, the POD 301 transmits a DATA packet obtained by dividing the communication data to the POD 301a and receives an ACK packet from the POD 301a as a reception acknowledgement of the DATA packet. Through plural times of repetition of this, the transmission of the communication data from the POD 301 to the POD 301a is carried out. This is also similar to transmission of communication data from the POD 301a to the POD 301b. Furthermore, this is also similar to transmission of communication data relating to span information from each of the PODs 301, 301a ,and 301b to the span collector 500.

FIG. 16 is a diagram illustrating a processing example of an information processing system.

The clients 800 and 900 access services provided by a POD group 330 of tenants through the network 50. Therefore, communication occurs between PODs that belong to the POD group 330. If the communication is a sampling target, each POD transmits span information to the span collector 500. All packets including packets associated with the communication between these PODs and packets associated with the transmission of the span information (notification packets) are duplicated (mirroring) by the switch that belongs to the network 50 and the duplicated packets are collected by the analysis apparatus 100.

The analysis apparatus 100 acquires filter information (for example, information on iptables) from a management component 410 in the span manager 400 (acquisition source of filter information may be a node other than the span manager 400). Based on the filter information, the analysis apparatus 100 filters off, from the received packets, packets other than packets from the clients 800, 900, . . . packets associated with the communication between PODs, and packets associated with the transmission of the span information (unrelated packets). The analysis apparatus 100 saves the collected packets in the store servers 600, 600a, . . . . The analysis apparatus 100 extracts the packets corresponding to the data flow of the sampling target based on the packets saved in the store server 600 and provides the analysis result of the packets to the management terminal 700.

Next, specific processing procedure by the analysis apparatus 100 will be described.

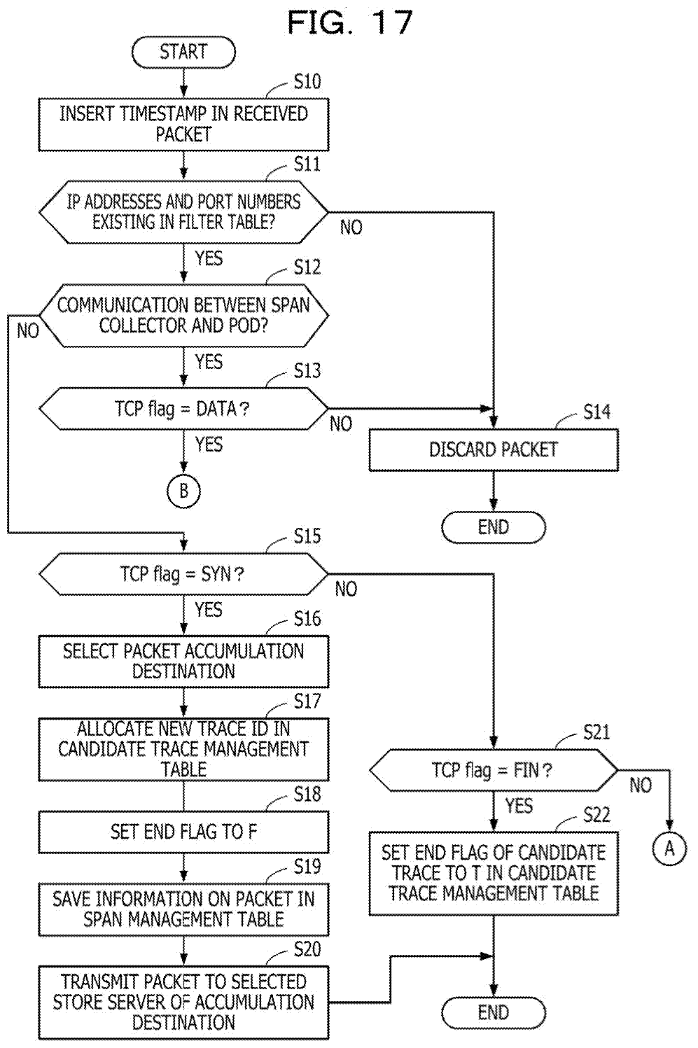

FIG. 17 is a flowchart illustrating a packet collection example.

The following procedure is started every time the analysis apparatus 100 receives a duplicated packet in the span matching period (predetermined periods before and after the next matching timing).

(S10) The clock time inserting unit 161 inserts a timestamp in a received packet.

(S11) The packet identifying unit 162 refers to the filter table 121 stored in the filter storing unit 120 and determines whether or not the set of transmission source IP address/port number and the set of destination IP address/port number regarding the received packet both match a set of IP address/port number registered in the filter table 121. If they match, the processing proceeds to a step 512. If they do not match, the processing proceeds to a step S14.

(S12) The span generation destination checking unit 172 refers to the flag in the filter table 121 and determines whether or not the received packet is a packet of communication between the span collector 500 and a POD. If the received packet is a packet of communication between the span collector 500 and a POD, the processing proceeds to a step 513. If the received packet is not a packet of communication between the span collector 500 and a POD, the processing proceeds to a step S15. If the received packet is a packet of communication between the span collector 500 and a POD, the set of destination IP address/destination port number of the packet represents the IP address/port number of the span collector 500 and the set of transmission source IP address/transmission source port number represents the IP address/port number of the POD.

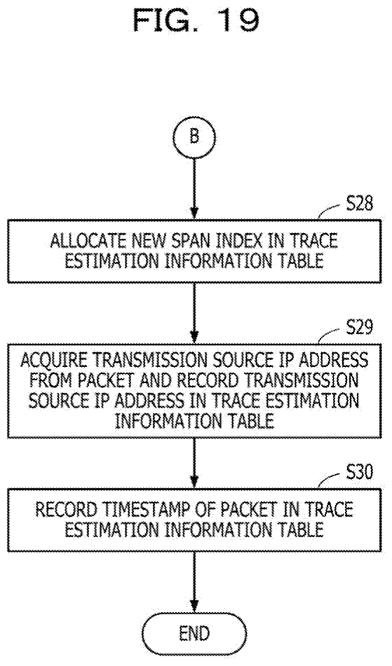

(S13) The data checking unit 171 determines whether or not the TCP flag in the TCP header 92 of the received packet represents DATA. If the TCP flag represents DATA, the processing proceeds to a step S28 in FIG. 19. If the TCP flag is not DATA, the processing proceeds to the step S14.

(S14) The packet identifying unit 162 (in the case of No in the step S11) or the data checking unit 171 (in the case of No in the step S13) discards the received packet. Then, the packet collection processing relating to the packet received this time ends.

(S15) The data checking unit 171 determines whether or not the TCP flag in the TCP header 92 of the received packet represents SYN. If the TCP flag represents SYN, the processing proceeds to a step S16. If the TCP flag is not SYN, the processing proceeds to a step S21. SYN represents transmission start of a request from the client 800, 900, . . . to the gateway 200 (equivalent to start of the data flow).

(S16) The packet trace allocating unit 181 selects the store server 600 that is the accumulation destination of the trace (data flow) corresponding to the received packet. For example, if plural store servers 600 exist, it is conceivable that the accumulation destination is selected based on the round robin, a hash value of information included in the packet (SYN packet), or the like.

(S17) The packet trace allocating unit 181 allocates a new trace ID to the trace (data flow) corresponding to the packet received this time in the candidate trace management table.

(S18) The packet trace allocating unit 181 sets the end flag corresponding to the new trace ID to “F.”

(S19) The packet trace allocating unit 181 saves information on the packet corresponding to the new trace ID in a new span management table.

(S20) The packet trace allocating unit 181 transmits the packet received this time in the selected store server 600 of the accumulation destination. Then, the packet collection processing relating to the packet received this time ends.

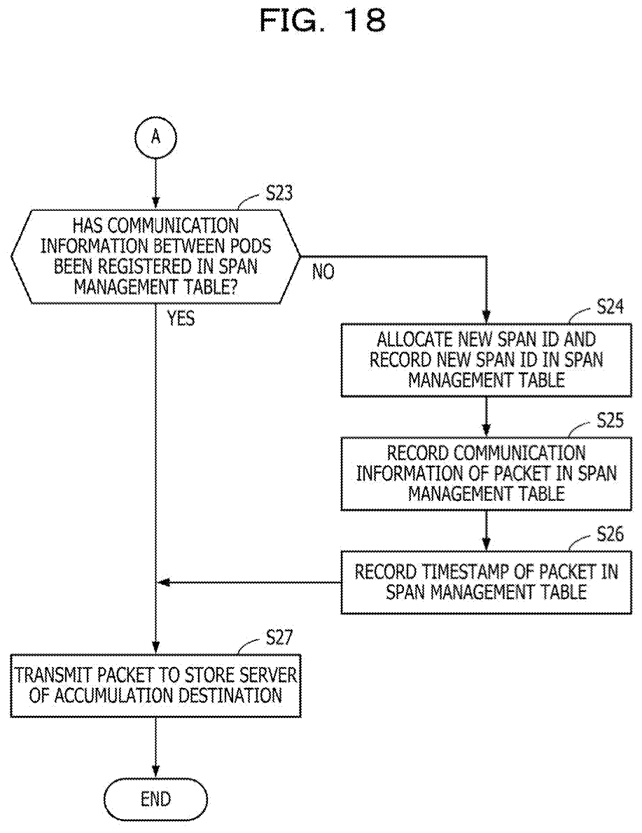

(S21) The data checking unit 171 determines whether or not the TCP flag in the TCP header 92 of the received packet represents FIN. If the TCP flag represents FIN, the processing proceeds to a step S22. If the TCP flag is not FIN, the processing proceeds to a step S23 in FIG. 18. FIN represents transmission completion of an acknowledgement from the gateway 200 to the client 800, 900, (equivalent to end of the data flow).

(S22) The packet trace allocating unit 181 identifies the trace (data flow) corresponding to the FIN packet received this time from the candidate trace management table 141 and sets the end flag of the trace to “T.” Then, the packet collection processing relating to the packet received this time ends.

FIG. 18 is a flowchart illustrating a packet collection example (sequel).

(S23) The span path estimating unit 182 determines whether or not the communication information between the PODs (including between the gateway 200 and the POD) corresponding to the received packet has been registered in the span management table. If the communication information has been registered, the processing proceeds to a step S27. If the communication information has not been registered, the processing proceeds to a step S24.

(S24) The span path estimating unit 182 allocates a new span ID to the received packet and records the new span ID in the span management table. The span path estimating unit 182 collates a first set of the destination IP address and the destination port number corresponding to the latest span ID in each existing span management table and a second set of the transmission source IP address and the transmission source port number of the received packet. The span path estimating unit 182 identifies the trace ID of the span management table in which the first set corresponds with the second set as the trace ID corresponding to the received packet.

(S25) The span path estimating unit 182 records the communication information (set of transmission source IP address/transmission source port number and set of destination IP address/destination port number) of the received packet in the span management table corresponding to the trace ID of the packet.

(S26) The span path estimating unit 182 records the timestamp of the received packet in the span management table corresponding to the trace ID of the packet.

(S27) The packet trace allocating unit 181 transmits the packet received this time to the store server 600 of the accumulation destination. Then, the packet collection processing relating to the packet received this time ends.

FIG. 19 is a flowchart illustrating a packet collection example (sequel).

(S28) The trace estimation information management unit 173 allocates a new span index in the trace estimation information table 131.

(S29) The trace estimation information management unit 173 acquires the transmission source IP address from the packet and records the transmission source IP address in the trace estimation information table 131.

(S30) The trace estimation information management unit 173 records the timestamp of the packet in the trace estimation information table 131. Then, the packet collection processing relating to the packet received this time ends.

By the above procedure, the trace estimation information table 131, the candidate trace management table 141, and the span management tables 142, . . . are generated. The candidate trace estimating unit 183 identifies the packets corresponding to the data flow of the sampling target in the collected packets based on the trace estimation information table 131, the candidate trace management table 141, and the span management tables 142, . . . .

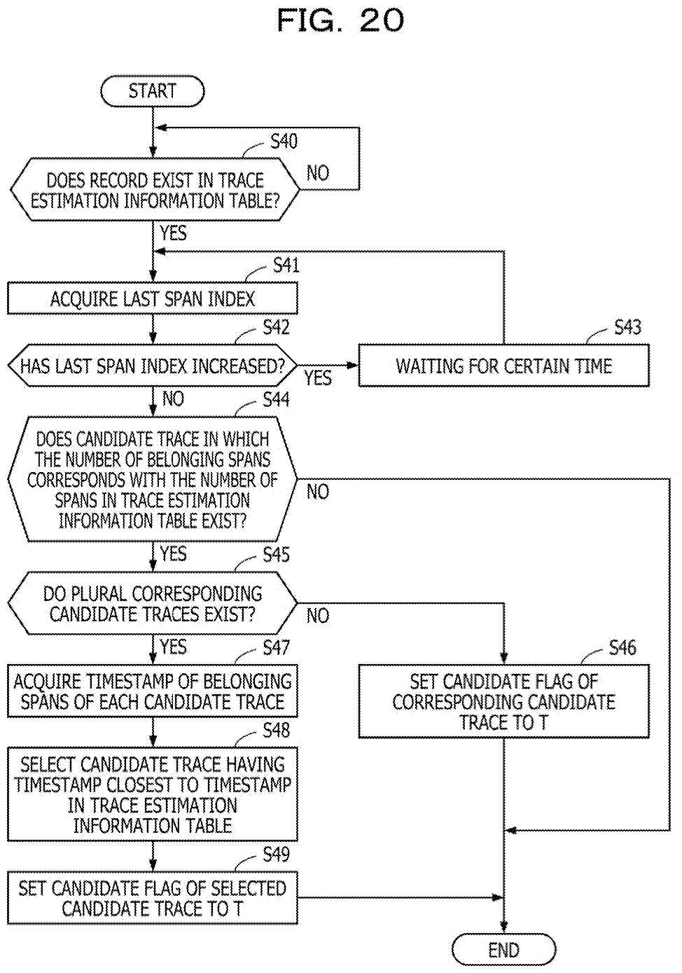

FIG. 20 is a flowchart illustrating an identification example of a packet.

The candidate trace estimating unit 183 executes the following procedure in the span matching period.

(S40) The candidate trace estimating unit 183 determines whether or not a record exists in the trace estimation information table 131. If a record exists in the trace estimation information table 131, the processing proceeds to a step S41. If a record does not exist, the processing proceeds to the step S40 (candidate trace estimating unit 183 waits until a record is registered in the trace estimation information table 131).

(S41) The candidate trace estimating unit 183 acquires the last span index (maximum span index) in the trace estimation information table 131.

(S42) The candidate trace estimating unit 183 determines whether or not the last span index has increased (record with a span index larger than the last span index has been registered in the trace estimation information table 131). If the span index has increased, the processing proceeds to a step S43. If the span index has not increased, the processing proceeds to a step S44.

(S43) The candidate trace estimating unit 183 waits for a certain time. Then, the processing proceeds to the step S41.

(S44) The candidate trace estimating unit 183 determines whether or not a candidate trace in which the number of belonging spans corresponds with the number of spans (the number of records or span index+1) in the trace estimation information table 131 exists. The number of belonging spans of the candidate trace is equivalent to the number of records (span ID+1) in the span management table 142 corresponding to each candidate trace. If the corresponding candidate trace exists, the processing proceeds to a step S45. If the corresponding candidate trace does not exist, the identification processing of the sampling-target packet ends. The absence of the corresponding candidate trace means failure in identifying the sampling-target packet.

(S45) The candidate trace estimating unit 183 determines whether or not plural traces exist as the candidate trace in which the number of belonging spans corresponds with the number of spans in the trace estimation information table 131, as the result of the determination of the step S44. If plural corresponding candidate traces exist, the processing proceeds to a step S47. If the number of corresponding candidate traces is one, the processing proceeds to a step S46.

(S46) The candidate trace estimating unit 183 sets the candidate flag of the corresponding candidate trace in the candidate trace management table 141 to “T.” For example, the candidate trace estimating unit 183 decides the packet having the communication information in the span management table corresponding to the candidate trace of the candidate flag “T” as the packet corresponding to the data flow of the sampling target. Then, the identification processing of the packet ends.

(S47) The candidate trace estimating unit 183 refers to the span management tables 142, . . . , 147 and acquires the timestamp of the belonging spans of each candidate trace (timestamp may be the timestamp of the representative span or be the representative value (for example, median) of the timestamps).

(S48) The candidate trace estimating unit 183 selects one candidate trace having the timestamp closest to the timestamp in the trace estimation information table 131 in the corresponding plural candidate traces. The timestamp in the trace estimation information table 131 may also be the timestamp of the representative transmission source or be the representative value (for example, median) of the timestamp registered in the trace estimation information table 131.

(S49) The candidate trace estimating unit 183 sets the candidate flag of the selected candidate trace in the candidate trace management table 141 to “T.” For example, the candidate trace estimating unit 183 decides the packet having the communication information in the span management table corresponding to the candidate trace of the candidate flag “T” as the packet corresponding to the data flow of the sampling target. Then, the identification processing of the packet ends.

As above, the analysis apparatus 100 generates plural traces (candidate flows) that are candidates for the data flow of the sampling target by tracking the transmission source address and the destination address of each collected packet. The analysis apparatus 100 identifies the data flow of the sampling target in the plural candidate flows according to comparison between a first number of nodes of the transmission sources of the notification packets to the span collector 500 and a second number of nodes that transfer packets included in the candidate flow regarding each candidate flow. For example, the analysis apparatus 100 identifies the candidate flow about which the first number and the second number are the same as the data flow of the sampling target. This may properly identify the data flow of the sampling target and the packets corresponding to the data flow.

Furthermore, in a case where two or more candidate flows about which the first number and the second number are the same exist, the analysis apparatus 100 identifies the data flow of the sampling target in the two or more candidate flows according to comparison between a first timestamp of the plural notification packets and a second timestamp of each of the two or more candidate flows. For example, the analysis apparatus 100 identifies the candidate flow corresponding to the second timestamp closest to the first timestamp as the data flow of the sampling target. This may properly identify the data flow of the sampling target and the packets corresponding to the data flow.

When the span matching period of this time ends, the trace estimation information table 131, the candidate trace management table 141, and the span management tables 142, . . . are cleared.

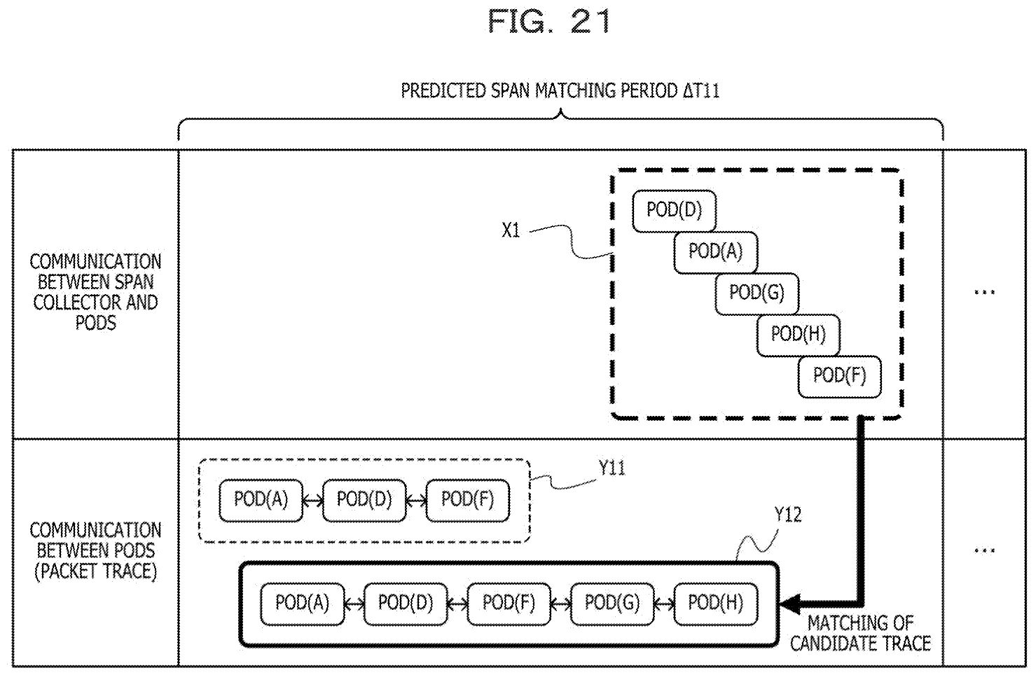

FIG. 21 is a diagram illustrating a first example of matching of a candidate trace.

For example, the analysis apparatus 100 detects packet traces Y11 and Y12 based on packets collected in a span matching period ΔT11. The packet trace Y11 is a data flow including communication between POD(A) and POD(D) and communication between POD(D) and POD(F) time-serially. The packet trace Y12 is a data flow including communication between POD(A) and POD(D), communication between POD(D) and POD(F), communication between POD(F) and POD(G), and communication between POD(G) and POD(H) time-serially.

Furthermore, suppose that the analysis apparatus 100 detects a POD group X1 as PODs that have transmitted data (notification packet) to the span collector 500 in the span matching period AT11. The POD group X1 includes POD(D), POD(A), POD(G), POD(H), and POD(F) time-serially in order of detection, for example.

In this case, the analysis apparatus 100 determines that the packet trace Y12 including all PODs included in the POD group X1 (including the same number of PODs as the POD group X1) in the packet traces Y11 and Y12 is the sampling target. As a result, the analysis apparatus 100 decides the packet group corresponding to the packet trace Y12 as the packet group corresponding to the data flow of the sampling target.

One example of the analysis sequence of the analysis apparatus 100 exemplified in FIG. 21 is as follows.

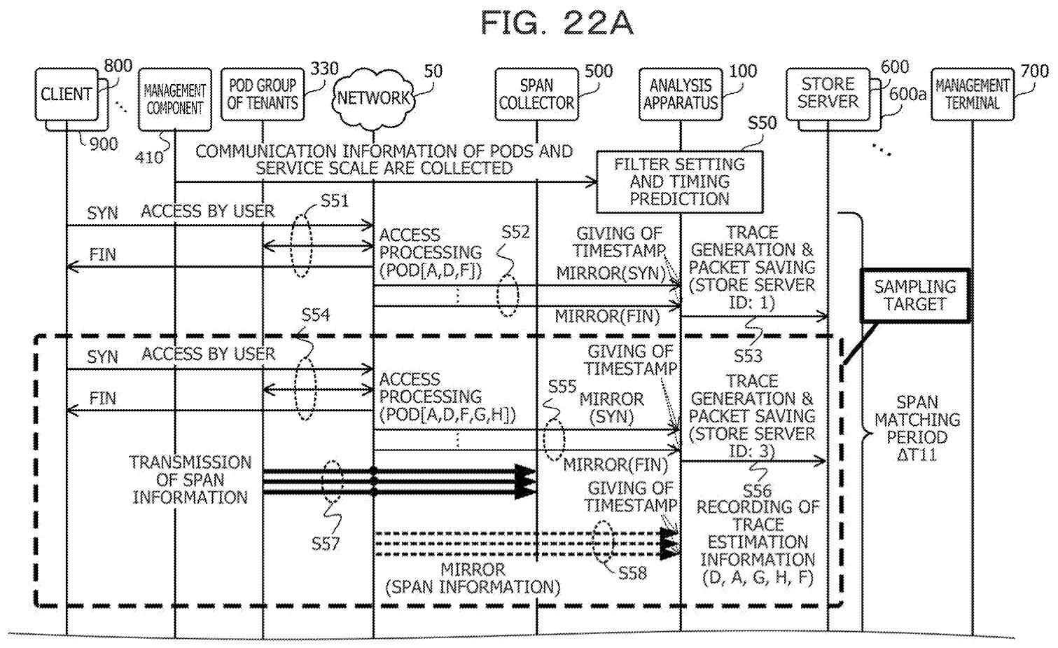

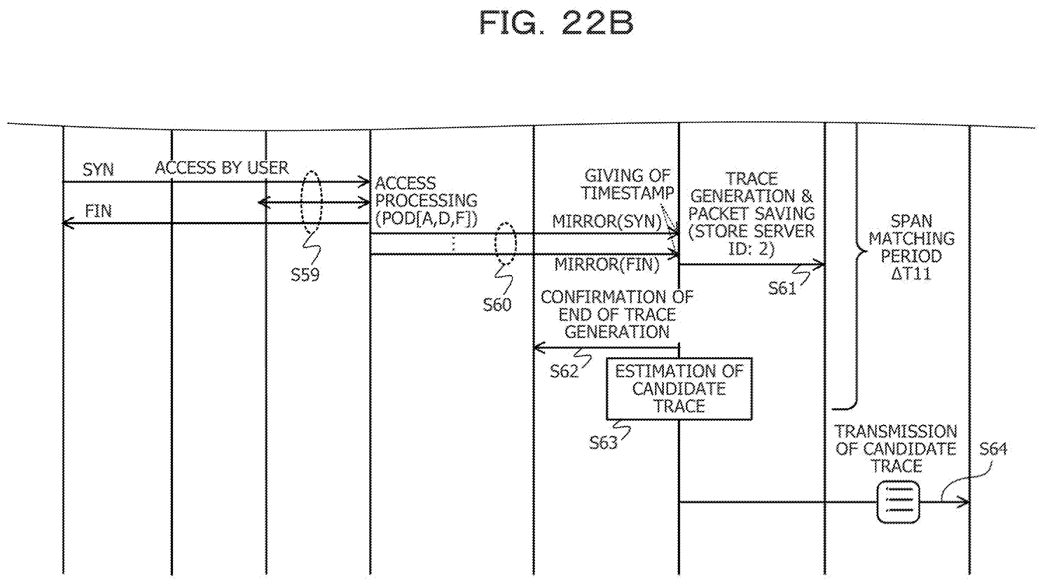

FIG. 22 is a diagram illustrating a first example of an analysis sequence.

(S50) The analysis apparatus 100 collects communication information of PODs, information on the scale of services, and so forth in iptables or the like from the management component 410, and carries out setting of the filter table 121 and prediction of the timings of start and end of the next span matching period. Steps S51 to S62 represented below are steps in the span matching period ΔT11.

(S51) The client 800 transmits a request for a service group provided by partial PODs included in the POD group 330 of tenants. The transmission of the request is started with a SYN packet from the client 800 to the gateway 200 (diagrammatic representation is omitted in FIG. 22). In response to the request, the partial PODs cooperate through the network 50 and execute given processing to return the processing result to the client 800. Here, suppose that three PODs [A, D, F] (POD(A), POD(D), and POD(F) are represented) cooperate in that order to execute the processing, for example. The return of the processing result is ended by a FIN packet from the gateway 200 to the client 800.

(S52) The given switch that belongs to the network 50 duplicates packets relating to the series of data flow from the SYN packet of the client 800 in the step S51 to the FIN packet to the client 800 and transmits the duplicated packets to the analysis apparatus 100.

(S53) The analysis apparatus 100 receives the duplicated packets and gives the timestamp to the packets to generate a trace of the packets corresponding to the data flow based on the received packets and save the packets in the store server with a store server ID “1.”

(S54) The client 800 (client may be another client) transmits a request for a service group provided by partial PODs included in the POD group 330 of tenants. In response to the request, the partial PODs cooperate through the network 50 and execute given processing to return the processing result to the client 800 (client of the request source). Here, suppose that five PODs [A, D, F, G, H] cooperate in that order to execute the processing, for example. Furthermore, suppose that the series of data flow in the step S54 corresponds to the sampling target decided by the span manager 400.

(S55) The given switch that belongs to the network 50 duplicates packets relating to the series of data flow from a SYN packet of the client 800 in the step S54 to a FIN packet to the client 800 and transmits the duplicated packets to the analysis apparatus 100.

(S56) The analysis apparatus 100 receives the duplicated packets and gives the timestamp to the packets to generate a trace of the packets corresponding to the data flow based on the received packets and save the packets in the store server with a store server ID “3.”

(S57) The PODs [A, D, F, G, H] in the POD group 330 of tenants transmit span information to the span collector 500 through the network 50.

(S58) The given switch that belongs to the network 50 duplicates packets of the span information and transmits the duplicated packets to the analysis apparatus 100. The analysis apparatus 100 gives the timestamp to the packets received in the step S58 and records trace estimation information (information on PODs [D, A, G, H, F]) in the trace estimation information table 131 based on the packets.

(S59) The client 800 (client may be another client) transmits a request for a service group provided by partial PODs included in the POD group 330 of tenants. In response to the request, the partial PODs cooperate through the network 50 and execute given processing to return the processing result to the client 800 (client of the request source). Here, suppose that three PODs [A, D, F] cooperate in that order to execute the processing, for example.

(S60) The given switch that belongs to the network 50 duplicates packets relating to the series of data flow from a SYN packet of the client 800 in the step S59 to a FIN packet to the client 800 and transmits the duplicated packets to the analysis apparatus 100.

(S61) The analysis apparatus 100 receives the duplicated packets and gives the timestamp to the packets to generate a trace of the packets corresponding to the data flow based on the received packets and save the packets in the store server with a store server ID “2.”

(S62) The analysis apparatus 100 detects that information on a new POD is not added to the trace estimation information (confirms end of trace generation). The analysis apparatus 100 may confirm with the span collector 500 about the end of trace generation.

(S63) The analysis apparatus 100 carries out estimation of the candidate trace. In the example of FIG. 22, the trace corresponding to the packet group collected in the step S55 is selected with respect to the trace estimation information generated in the step S58 as exemplified in FIG. 21.

(S64) The analysis apparatus 100 transmits information indicating the candidate trace to the management terminal 700. The management terminal 700 may access the store server 600 and acquire the contents of the packets that belong to the candidate trace based on the information indicating the candidate trace.

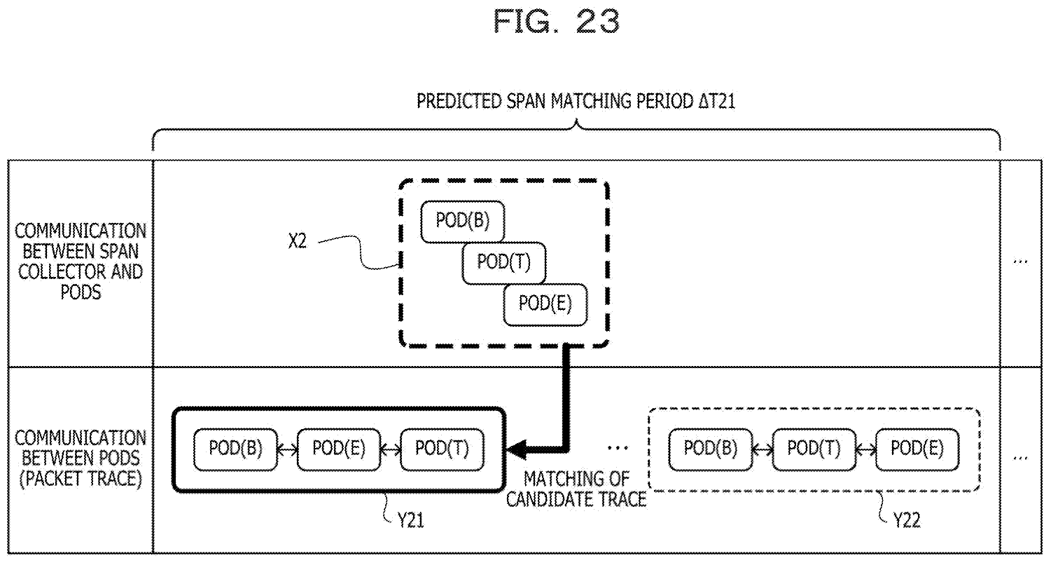

FIG. 23 is a diagram illustrating a second example of matching of a candidate trace.

For example, the analysis apparatus 100 detects packet traces Y21 and Y22 based on packets collected in a span matching period ΔT21. The packet trace Y21 is a data flow including communication between POD(B) and POD(E) and communication between POD(E) and POD(T) time-serially. The packet trace Y22 is a data flow including communication between POD(B) and POD(T) and communication between POD(T) and POD(E) time-serially.

Furthermore, suppose that the analysis apparatus 100 detects a POD group X2 as PODs that have transmitted data (notification packet) to the span collector 500 in the span matching period ΔT21. The POD group X2 includes POD(B), POD(T), and POD(E) time-serially in order of detection, for example.

In this case, both of the packet traces Y21 and Y22 include all PODs included in the POD group X2 (the same number of PODs as the POD group X2). In this case, the analysis apparatus 100 determines that the packet trace Y21 detected at a clock time closer to the clock time when the POD group X2 has been detected in the packet traces Y21 and Y22 is the sampling target. As a result, the analysis apparatus 100 decides the packet group corresponding to the packet trace Y21 as the packet group corresponding to the data flow of the sampling target.

One example of the analysis sequence of the analysis apparatus 100 exemplified in FIG. 23 is as follows.

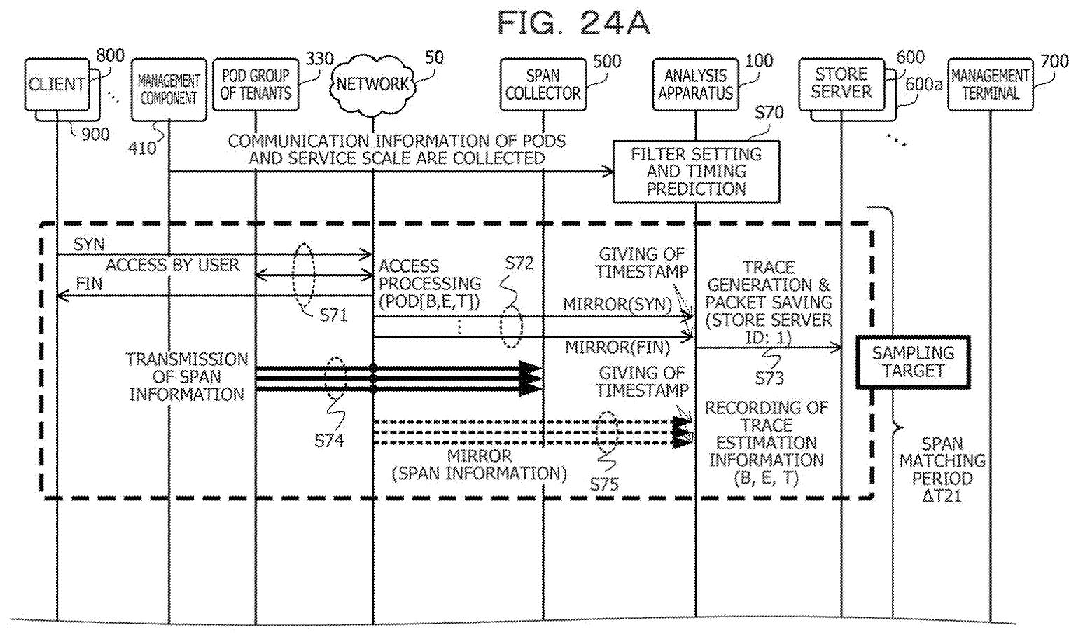

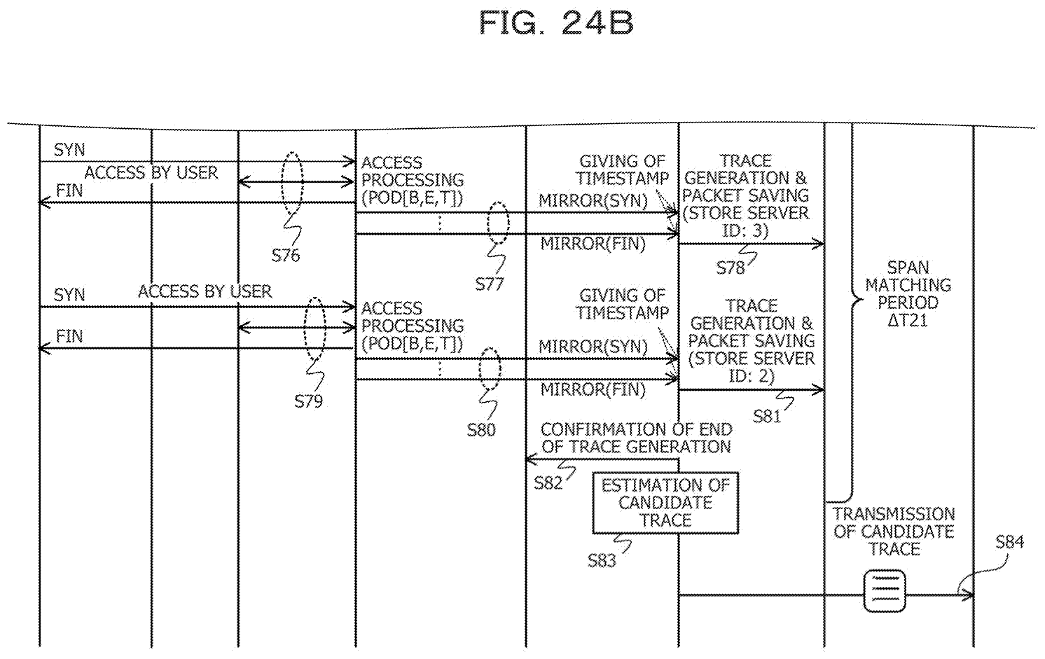

FIG. 24 is a diagram illustrating a second example of an analysis sequence.

(S70) The analysis apparatus 100 collects communication information of PODs, information on the scale of services, and so forth in iptables or the like from the management component 410, and carries out setting of the filter table 121 and prediction of the timings of start and end of the next span matching period. Steps S71 to S82 represented below are steps in the span matching period ΔT21.

(S71) The client 800 transmits a request for a service group provided by partial PODs included in the POD group 330 of tenants. The transmission of the request is started with a SYN packet from the client 800 to the gateway 200 (diagrammatic representation is omitted in FIG. 24). In response to the request, the partial PODs cooperate through the network 50 and execute given processing to return the processing result to the client 800. Here, suppose that three PODs [B, E, T] cooperate in that order to execute the processing, for example. The return of the processing result is ended by a FIN packet from the gateway 200 to the client 800. Furthermore, suppose that the series of data flow in the step S71 corresponds to the sampling target decided by the span manager 400.

(S72) The given switch that belongs to the network 50 duplicates packets relating to the series of data flow from the SYN packet of the client 800 in the step S71 to the FIN packet to the client 800 and transmits the duplicated packets to the analysis apparatus 100.

(S73) The analysis apparatus 100 receives the duplicated packets and gives the timestamp to the packets to generate a trace of the packets corresponding to the data flow based on the received packets and save the packets in the store server with a store server ID “1.”

(S74) The PODs [B, E, T] in the POD group 330 of tenants transmit span information to the span collector 500 through the network 50.

(S75) The given switch that belongs to the network 50 duplicates packets of the span information and transmits the duplicated packets to the analysis apparatus 100. The analysis apparatus 100 gives the timestamp to the packets received in the step S75 and records trace estimation information (information on PODs [B, E, T]) in the trace estimation information table 131 based on the packets.

(S76) The client 800 (client may be another client) transmits a request for a service group provided by partial PODs included in the POD group 330 of tenants. In response to the request, the partial PODs cooperate through the network 50 and execute given processing to return the processing result to the client 800 (client of the request source). Here, suppose that three PODs [B, E, T] cooperate in that order to execute the processing, for example.

(S77) The given switch that belongs to the network 50 duplicates packets relating to the series of data flow from a SYN packet of the client 800 in the step S76 to a FIN packet to the client 800 and transmits the duplicated packets to the analysis apparatus 100.

(S78) The analysis apparatus 100 receives the duplicated packets and gives the timestamp to the packets to generate a trace of the packets corresponding to the data flow based on the received packets and save the packets in the store server with a store server ID “3.”

(S79) The client 800 (client may be another client) transmits a request for a service group provided by partial PODs included in the POD group 330 of tenants. In response to the request, the partial PODs cooperate through the network 50 and execute given processing to return the processing result to the client 800 (client of the request source). Here, suppose that three PODs [B, E, T] cooperate in that order to execute the processing, for example.

(S80) The given switch that belongs to the network 50 duplicates packets relating to the series of data flow from a SYN packet of the client 800 in the step S79 to a FIN packet to the client 800 and transmits the duplicated packets to the analysis apparatus 100.

(S81) The analysis apparatus 100 receives the duplicated packets and gives the timestamp to the packets to generate a trace of the packets corresponding to the data flow based on the received packets and save the packets in the store server with a store server ID “2.”

(S82) The analysis apparatus 100 detects that information on a new POD is not added to the trace estimation information (confirms end of trace generation). The analysis apparatus 100 may confirm with the span collector 500 about the end of trace generation.

(S83) The analysis apparatus 100 carries out estimation of the candidate trace. In the example of FIG. 24, with respect to the trace estimation information generated in the step S75, the trace corresponding to the packet group collected in the step S72 closest in terms of time is selected as exemplified in FIG. 23.

(S84) The analysis apparatus 100 transmits information indicating the candidate trace to the management terminal 700. The management terminal 700 may access the store server 600 and acquire the contents of the packets that belong to the candidate trace based on the information indicating the candidate trace.

As above, the analysis apparatus 100 does not execute processing of the HTTP header (configuring of the HTTP header from a packet group and analysis of the HTTP header) and the time for the search for packets relating to the trace (data flow) of the sampling target may be shortened.

For example, the following basic conditions will be considered. (1) Four store servers 600 exist. (2) The time for processing of one HTTP header is 60 seconds. (3) The time taken for the search for a packet corresponding to certain one span existing in a certain store server is 20 seconds. (4) The time for transmission of information on a trace (including five spans) to the management terminal 700 is 40 seconds. (5) The number of spans included in a trace is five.

Regarding the above-described basic conditions, a method in which packets are collected in units of connection and the HTTP header is processed to search for a trace will be considered as a comparative example. In this case, suppose that packets corresponding to two spans exist in a first store server and a packet corresponding to one span exists in each of second, third, and fourth store servers. In this case, the time for the processing of the HTTP header is 60 seconds×5=300 seconds. The time taken for the search for the packet of the one span existing in each of the other store servers is 20 seconds×3=60 seconds. Thus, the total time for the processing of the comparative example is 300 seconds+60 seconds+40 seconds (transmission time)=400 seconds.

On the other hand, in the search for a trace by the analysis apparatus 100, packets corresponding to all spans of the trace exist in one store server (for example, second store server). In this case, the time for the processing of the HTTP header disappears (0 seconds) and the time for the search for the packets stored in the other store servers also disappears (0 seconds). The total time for the processing by the analysis apparatus 100 is 0 seconds+0 seconds+40 seconds (transmission time)=40 seconds.

For example, in the example with the above-described basic conditions, according to the analysis apparatus 100, the time for providing packets of the relevant trace to the management terminal 700 may be shortened to 1/10 compared with the method of the comparative example.

In this manner, it becomes possible to monitor the quality of the communication path used for cooperation between services in real time and carry out analysis.

It is also possible to implement the respective functions of the analysis apparatus 100 exemplified in FIG. 9 by a hardware.

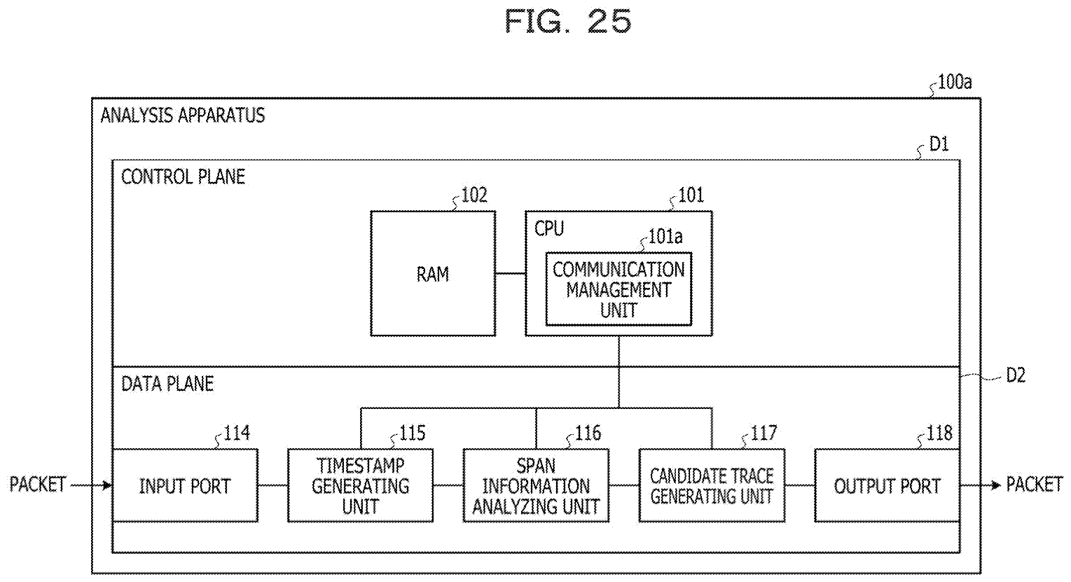

FIG. 25 is a diagram illustrating another hardware example of an analysis apparatus.

An analysis apparatus 100a is used instead of the analysis apparatus 100 in the information processing system of the second embodiment. The analysis apparatus 100a includes a control plane D1 and a data plane D2. The control plane D1 provides a control function by a program. The data plane D2 provides a packet processing function by an electronic circuit exclusively for packet processing.

The control plane D1 includes a CPU 101 and a RAM 102. The CPU 101 executes a program stored in the RAM 102. The RAM 102 stores the program executed by the CPU 101. For example, in the analysis apparatus 100a, the CPU 101 exerts functions of a communication management unit 101a corresponding to the communication management unit 190 exemplified in FIG. 9 by executing the program.

The data plane D2 includes an input port 114, a timestamp generating unit 115, a span information analyzing unit 116, a candidate trace generating unit 117, and an output port 118.

The input port 114 is a communication interface that receives packets duplicated by a given switch that belongs to the network 50.

The timestamp generating unit 115 is a hardware such as an ASIC or an FPGA having functions of the timestamp generating unit 160. The timestamp generating unit 115 includes a local memory and uses a storage area of the local memory as a storing unit equivalent to the filter storing unit 120.

The span information analyzing unit 116 is a hardware such as an ASIC or an FPGA having functions of the span information analyzing unit 170. The span information analyzing unit 116 includes a local memory and uses a storage area of the local memory as a storing unit equivalent to the trace estimation information storing unit 130.

The candidate trace generating unit 117 is a hardware such as an ASIC or an FPGA having functions of the candidate trace generating unit 180. The candidate trace generating unit 117 includes a local memory and uses a storage area of the local memory as a storing unit equivalent to the candidate trace storing unit 140.

As above, the analysis apparatus 100a in which the respective functions of the timestamp generating unit 160, the span information analyzing unit 170, and the candidate trace generating unit 180 which the analysis apparatus 100 includes are implemented by hardware may be used. In both the case of using the analysis apparatus 100 and the case of using the analysis apparatus 100a, for example, the timestamp generating units 115 and 160 and the span information analyzing units 116 and 170 may enhance the speed of analysis processing by executing analysis on received plural packets in parallel by pipeline control or the like.

Incidentally, in recent years, monitoring of micro-services has been carried out. In the monitoring, identification information called Annotation is inserted in a message of Method calling and a timestamp is added to the message at the timing when Method is called, and processing delay between micro-services may be measured by the timestamp. Information on the relationship of calling between micro-services and the processing time is referred to as span and a group of plural spans is referred to as trace. However, such a monitoring method is for the HTTP message of layer 7 and it is difficult to investigate the actual cause without packet capture data even when delay increases. Furthermore, in order to search for packets corresponding to a trace, a desired connection is retrieved from packet data captured from plural points of a network and thereafter an HI I P header is reconstructed and character string processing is executed. Meanwhile, the processing time relating to the processing of the HTTP header often becomes long by a factor of approximately ten compared with TCP analysis of layer 4.

Thus, the analysis apparatus 100 extracts packet data corresponding to a trace without executing processing of the HTTP header (reconstruction and analysis). For example, the analysis apparatus 100 integrates and collects captured packets and inserts a timestamp in all packets. Furthermore, the analysis apparatus 100 sets, as a filter, communication information on desired PODs from setting information of the management component of the system. The analysis apparatus 100 configures the relationship of calling of services from packets resulting from filtering and creates candidate traces. The analysis apparatus 100 excludes what has no relation to the actual trace from the candidate traces based on trace estimation information according to communication between the PODs and the span collector 500. In this manner, the analysis apparatus 100 may extract the packet data corresponding to the data flow (trace) of the sampling target at high speed without executing the processing of the HTTP header.

The information processing of the first embodiment may be implemented by causing the processing unit 12 to execute a program. Furthermore, the information processing of the second embodiment may be implemented by causing the CPU 101 to execute a program. The program may be recorded on the computer-readable recording medium 113.

For example, the program may be circulated by distributing the recording medium 113 on which the program is recorded. The program may be stored in another computer and the program may be distributed via a network. For example, the computer may store (install) the program recorded on the recording medium 113 or the program received from another computer in a storing apparatus such as the RAM 102 or the HDD 103 and the program may be read from the storing apparatus to be executed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor included in computer to execute a process, the process comprising:
collecting packets transmitted among a plurality of nodes including a plurality of first nodes that provide services and communicate with each other and a second node that receives a notification packet indicating that a packet corresponding to a data flow of a sampling target has been transferred from each of the plurality of first nodes;
identifying a plurality of notification packets whose destination is the second node in the collected packets, and acquiring a plurality of transmission source addresses of the plurality of notification packets identified; and
extracting, from the collected packets, a plurality of candidate packets having a set of two addresses in the plurality of transmission source addresses acquired as a transmission source and a destination, and deciding a set of packets corresponding to the data flow of the sampling target from the plurality of candidate packets extracted.

2. The storage medium according to claim 1, wherein
a plurality of candidate flows that are candidates for the data flow of the sampling target are generated by tracking a transmission source address and a destination address of each of the plurality of candidate packets, and the data flow of the sampling target is identified in the plurality of candidate flows according to comparison between a first number of nodes of transmission sources of the plurality of notification packets and a second number of nodes that transfer candidate packets in the candidate flow regarding each of the candidate flows.

3. The storage medium according to claim 2, wherein
the candidate flow about which the first number and the second number are same is identified as the data flow of the sampling target.

4. The storage medium according to claim 3, wherein,
in a case where two or more candidate flows about which the first number and the second number are same exist, the data flow of the sampling target is identified in the two or more candidate flows according to comparison between a first timestamp of the plurality of notification packets and a second timestamp of each of the two or more candidate flows.

5. The storage medium according to claim 4, wherein
the candidate flow corresponding to the second timestamp closest to the first timestamp is identified as the data flow of the sampling target.

6. A packet analysis apparatus comprising:
a memory configured to store packets transmitted among a plurality of nodes including a plurality of first nodes that provide services and communicate with each other and a second node that receives a notification packet indicating that a packet corresponding to a data flow of a sampling target has been transferred from each of the plurality of first nodes; and
a circuit configured to collect the packets transmitted among the plurality of nodes and store the packets in the memory, the circuit identifying a plurality of notification packets whose destination is the second node in the collected packets and acquiring a plurality of transmission source addresses of the plurality of notification packets identified, the circuit extracting, from the collected packets, a plurality of candidate packets having a set of two addresses in the plurality of transmission source addresses acquired as a transmission source and a destination and deciding a set of packets corresponding to the data flow of the sampling target from the plurality of candidate packets extracted.

7. The packet analysis apparatus according to claim 6, wherein
the circuit generates a plurality of candidate flows that are candidates for the data flow of the sampling target by tracking a transmission source address and a destination address of each of the plurality of candidate packets, and identifies the data flow of the sampling target in the plurality of candidate flows according to comparison between a first number of nodes of transmission sources of the plurality of notification packets and a second number of nodes that transfer candidate packets in the candidate flow regarding each of the candidate flows.

8. The packet analysis apparatus according to claim 7, wherein
the circuit identifies the candidate flow about which the first number and the second number are same as the data flow of the sampling target.

9. The packet analysis apparatus according to claim 8, wherein,
in a case where two or more candidate flows about which the first number and the second number are same exist, the circuit identifies the data flow of the sampling target in the two or more candidate flows according to comparison between a first timestamp of the plurality of notification packets and a second timestamp of each of the two or more candidate flows.

10. The packet analysis apparatus according to claim 9, wherein
the circuit identifies the candidate flow corresponding to the second timestamp closest to the first timestamp as the data flow of the sampling target.

11. A packet analysis method comprising, by a computer:
collecting packets transmitted among a plurality of nodes including a plurality of first nodes that provide services and communicate with each other and a second node that receives a notification packet indicating that a packet corresponding to a data flow of a sampling target has been transferred from each of the plurality of first nodes;
identifying a plurality of notification packets whose destination is the second node in the collected packets, and acquiring a plurality of transmission source addresses of the plurality of notification packets identified; and
extracting, from the collected packets, a plurality of candidate packets having a set of two addresses in the plurality of transmission source addresses acquired as a transmission source and a destination, and deciding a set of packets corresponding to the data flow of the sampling target from the plurality of candidate packets extracted.
